(19) United States
(12) Patent Application Publication
(10) Pub. No.: US 2023/0347428 A1
(43) Pub. Date: Nov. 2, 2023

(54) TOOL AND MACHINING DEVICE AND METHOD OF MACHINING

(71) Applicant: Nidec Machine Tool Corporation, Shiga (JP)

(72) Inventors: Tatsuro TAKAGI, Shiga (JP); Govinda PARASRAMPURIA, Shiga (JP)

(21) Appl. No.: 18/309,749

(22) Filed: Apr. 28, 2023

(30) Foreign Application Priority Data
Apr. 28, 2022 (JP) 2022-074152
Mar. 27, 2023 (JP) 2023-049406

(51) Int. Cl. B23G 5/18; B23G 1/32

(52) U.S. Cl. CPC B23G 5/18; B23G 1/32

(57) ABSTRACT

A tool includes a tool body extending along a tool axis, and a thread protruding in a direction away from the tool axis on an outer surface of the tool body and provided in a spiral shape about the tool axis. The thread includes a first region located on one side in a spiral direction and a reference region located on another side in the spiral direction with respect to the first region. The first region includes a one-side tooth flank that is a surface on one side in a tool axial direction and an other-side tooth flank that is a surface on the other side in the tool axial direction. The reference region includes a one-side tooth flank that is a surface on one side in the tool axial direction and another-side tooth flank that is a surface on the other side in the tool axial direction.

### CROSS REFERENCE TO RELATED APPLICATIONS

The present application claims priority under 35 U.S.C. § 119 to Japanese Application No. 2022-074152, filed on Apr. 28, 2022, and Japanese Application No. 2023-049406, filed on Mar. 27, 2023, the entire contents of each application being hereby incorporated herein by reference.

### 1. FIELD OF THE INVENTION

The present disclosure relates to a tool, a machining device, and a method of machining.

### 2. BACKGROUND

Conventionally, after gear cutting, a tooth edge between a gear end surface and a tooth surface may be chamfered in order to remove burrs generated by the cutting and to remove sharp corners. As an example of a chamfering tool, a chamfering hob capable of machining left and right tooth edges of a gear in a single process is known.

However, in the case of the chamfering hob in which the left and right tooth edges are machined in a single process, there are many restrictions on the shape of the hob cutter. Therefore, the right and left tooth edges may be chamfered one by one in separate steps. At this time, when the hob cutter and the gear are synchronously rotated and the individual threads of the hob cutter sequentially machine the gear, a part of the thread and a part of the gear may interfere with each other. In order to avoid the interference, there is a case where design restriction is imposed on the profile of the blade surface of the thread.

### SUMMARY

An example embodiment of the present disclosure is a tool including a tool body extending along a tool axis, and a thread protruding in a direction away from the tool axis on an outer surface of the tool body and provided in a spiral shape about the tool axis. The thread includes a first region located on one side in the spiral direction, and a reference region located on another side in the spiral direction with respect to the first region. The first region includes a one-side tooth flank that is a surface on one side in a tool axial direction, and another-side tooth flank which is a surface on another side in the tool axial direction. The reference region includes a one-side tooth flank that is a surface on one side in the tool axial direction, and another-side tooth flank that is a surface on another side in the tool axial direction. In at least one of the one-side tooth flank and the other-side tooth flank in a tooth profile of the reference region, an angle between an inner region disposed on a tool axis side and the outer surface of the tool body is smaller than an angle between an outer region which is located in a direction farther from the tool axis than the inner region and an outer surface of the tool body. The other-side tooth flank in the first region is recessed more than the other-side tooth flank in the reference region.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a front view of a machining device according to an example embodiment of the present disclosure.

FIG. 2 is a plan view of the machining device.

FIG. 3 is a perspective view of a gear according to an example embodiment of the present disclosure.

FIG. 4 is a perspective view of a tool according to an example embodiment of the present disclosure.

FIG. 5 is a perspective view of the tool.

FIG. 6 is a side view of the tool.

FIG. 7 is a plan view of the tool.

FIG. 8 is a diagram illustrating a tooth profile of a thread according to an example embodiment of the present disclosure.

FIG. 9 is a side view of the tool.

FIG. 10 is a bottom view of the tool.

FIG. 11 is a diagram illustrating a tooth profile of a thread according to an example embodiment of the present disclosure.

FIG. 12 is a view in which tooth profiles of the threads are overlapped.

FIG. 13 is a flowchart illustrating a flow of operation of the machining device.

FIG. 14 is a flowchart illustrating a flow of processing according to an example embodiment of the present disclosure.

FIG. 15 is a diagram illustrating how a first tooth surface is machined according to an example embodiment of the present disclosure.

FIG. 16 is a diagram illustrating how a second tooth surface is machined according to an example embodiment of the present disclosure.

FIG. 17 is a perspective view of a tool having a relieved portion on a right tooth flank of a thread according to an example embodiment of the present disclosure.

FIG. 18 is a perspective view of a tool having a relieved portion on both sides of a thread according to an example embodiment of the present disclosure.

FIG. 19 is a side view of the tool.

FIG. 20 is a bottom view of the tool.

FIG. 21 is a plan view of the tool.

FIG. 22 is a diagram illustrating a tooth profile of a thread according to an example embodiment of the present disclosure.

FIG. 23 is a diagram illustrating the tooth profile of the thread in an overlapping manner.

FIG. 24 is a perspective view of a tool which is a grindstone cutter according to an example embodiment of the present disclosure.

FIG. 25 is a side view of the tool.

FIG. 26 is a bottom view of the tool.

FIG. 27 is a diagram illustrating a tooth profile of a thread according to an example embodiment of the present disclosure.

FIG. 28 is a diagram illustrating the tooth profile of a thread in an overlapping manner.

### DETAILED DESCRIPTION

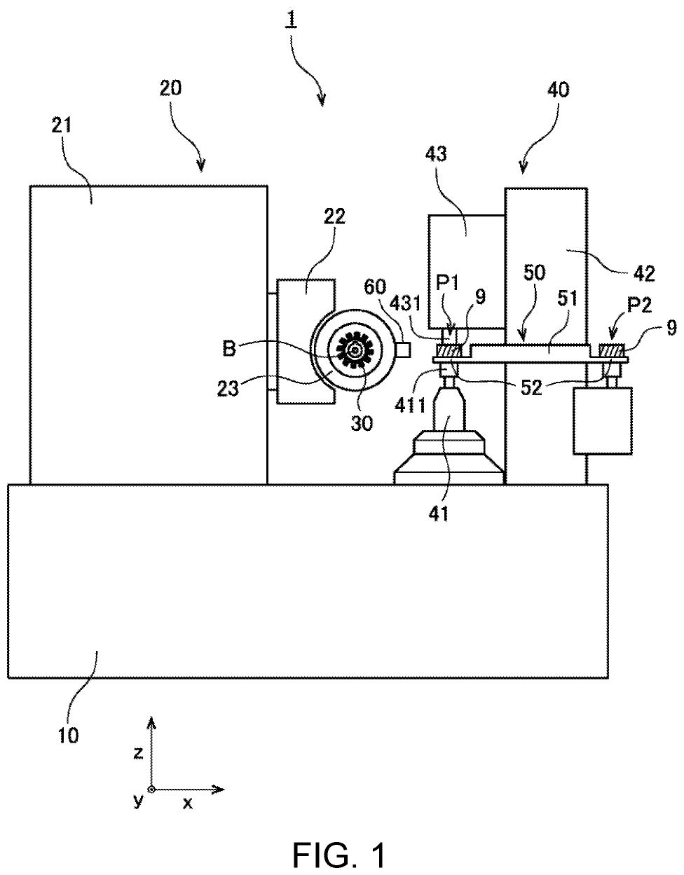

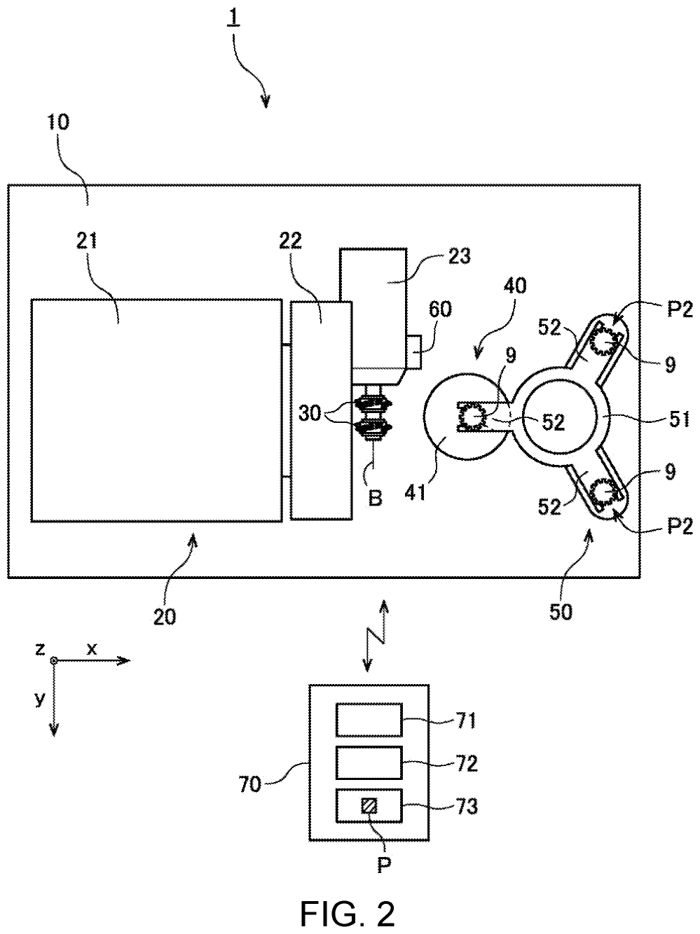

FIG. 1 is a front view of a machining device 1 according to an example embodiment. FIG. 2 is a plan view of the machining device 1. FIGS. 1 and 2 illustrate an x direction, a y direction, and a z direction. In the present example embodiment, the x direction and the y direction are horizontal directions and directions orthogonal to each other. In the present example embodiment, the z direction is a vertical direction. However, the definitions of the x direction, the y direction, and the z direction do not limit the posture of the machining device according to the present disclosure. That is, the x direction and the y direction may be directions other than the horizontal direction. Further, the z direction may be a direction other than the vertical direction.

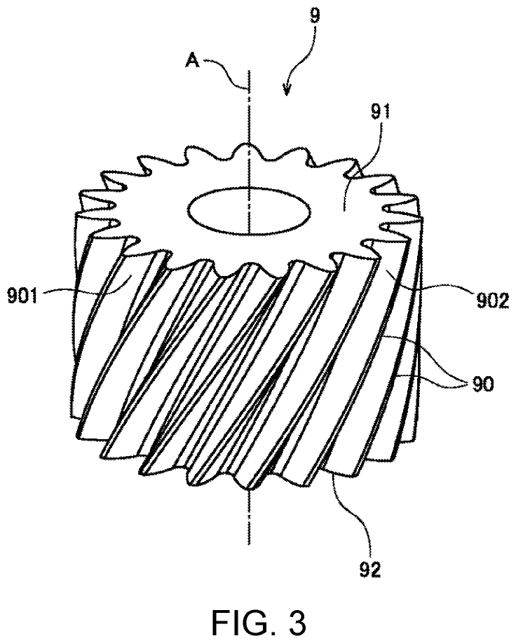

The machining device 1 is a device that machines a gear 9. FIG. 3 is a perspective view of the gear 9. The gear 9 in FIG. 3 is a helical gear. The gear 9 has an annular shape centered on a gear axis A. The gear 9 has a first end surface 91 and a second end surface 92. The first end surface 91 is one end surface of the gear 9 in a direction parallel to the gear axis A. The second end surface 92 is the other end surface of the gear 9 in the direction parallel to the gear axis A. The gear 9 has a plurality of external teeth 90. The plurality of external teeth 90 protrude in a direction away from the gear axis A on the outer surface of the gear 9.

In the present example embodiment, the gear 9 has the plurality of external teeth 90, but the gear may have a plurality of internal teeth. In this case, the machining device and the tool included in the machining device are used to machine the internal teeth of the gear. In the following description, a case where the machining device 1 machines the gear 9 having the external teeth 90 will be described.

As illustrated in FIG. 3, the plurality of external teeth 90 extend spirally around the gear axis A. Each external tooth 90 has a first tooth surface 901 and a second tooth surface 902. The first tooth surface 901 is a surface on one side of the external tooth 90 in the circumferential direction around the gear axis A. The second tooth surface 902 is a surface on the other side of the external tooth 90 in the circumferential direction around the gear axis A. The first tooth surface 901 extends toward one side in the circumferential direction from the second end surface 92 toward the first end surface 91. That is, when viewed from the first end surface 91 toward the second end surface 92 along the gear axis A, the first tooth surface 901 is an acute angle surface. The second tooth surface 902 extends toward the other side in the circumferential direction from the second end surface 92 toward the first end surface 91. That is, when viewed from the first end surface 91 toward the second end surface 92 along the gear axis A, the second tooth surface 902 is an obtuse angle surface.

The machining device 1 of the present example embodiment chamfers the outer edge portion of the first end surface 91 and the outer edge portion of the second end surface 92 of the gear 9 by cutting. In other words, the machining device 1 of the present example embodiment performs chamfering processing on the end portion of the external tooth 90 on the first end surface 91 side and the end portion of the external tooth 90 on the second end surface 92 side by cutting.

As illustrated in FIGS. 1 and 2, the machining device 1 includes a tool driver 20, two tools 30, and a gear driver 40. In addition, the machining device 1 of the present example embodiment further includes a bed 10, a changer 50, a phase sensor 60, and a controller 70. The number of tools 30 may be one or three or more. Thus, for example, a plurality of types of gears can be machined. Since the machining device 1 includes the tool 30, the gear 9 can be appropriately machined while suppressing contact between the tool 30 and the gear 9 by a mechanism to be described later.

The bed 10 is a support base that supports the tool driver 20 and the gear driver 40. The bed 10 is formed of rolled steel having high rigidity. The bed 10 is installed on a floor surface of a factory that manufactures the gear 9. In FIG. 1, the bed 10 has a flat plate shape, and the tool driver 20 and the gear driver 40 are supported on an upper surface of the bed. However, the bed 10 may have a housing shape having a bottom plate portion, a side wall portion, and a top plate portion, and the tool driver 20 and the gear driver 40 may be accommodated in the housing shape. The tool driver 20 and the gear driver 40 are disposed side by side in the x direction.

The tool driver 20 is a mechanism that moves and rotates the tool 30. The tool driver 20 moves the tool 30 in the x direction, the y direction, and the z direction. The tool driver 20 rotates the tool 30 about a tool axis B. As illustrated in FIGS. 1 and 2, the tool driver 20 includes a column 21, a saddle 22, and a tool head 23.

The column 21 is movable in the x direction with respect to the bed 10 by a first drive mechanism (not illustrated). The saddle 22 is provided on a surface of the column 21 facing the gear driver 40. The saddle 22 is movable in the z direction with respect to the column 21 by a second drive mechanism (not illustrated).

The tool head 23 is attached to the saddle 22. The tool head 23 is movable in the y direction with respect to the saddle 22 by a third drive mechanism (not illustrated). The tool head 23 is rotatable about a rotation axis extending in the y direction by a fourth drive mechanism (not illustrated). In addition, the tool head 23 can incline the rotation axis from the y direction in the yz plane by a fifth drive mechanism (not illustrated).

The tool 30 is a component for machining the gear 9. The tool 30 of the present example embodiment is a hob cutter that performs chamfering of the gear 9. The hob cutter is preferred because secondary burrs due to chamfering are not generated, chamfering quality is excellent, and productivity is high. The tool 30 is formed of an alloy such as high speed steel or cemented carbide, for example. The tool 30 is detachable from the tool head 23. In a state where the tool 30 is attached to the tool head 23, the rotation axis of the tool head 23 and the tool axis B that is the central axis of the tool 30 are coaxially disposed.

When the first drive mechanism, the second drive mechanism, and the third drive mechanism described above are operated with the tool 30 attached to the tool head 23, the tool 30 moves in the x direction, the y direction, and the z direction together with the tool head 23. When the fifth drive mechanism is operated with the tool 30 attached to the tool head 23, the tool axis B of the tool 30 is inclined with respect to the y direction. When the above-described fourth drive mechanism is operated, the tool 30 rotates about the tool axis B. The position and the rotation phase of the tool 30 in the tool axis B direction are managed. This enables phase matching between the tool 30 and a gear 90 described later.

In the present example embodiment, two tools 30 are attached to the tool head 23. One of the two tools 30 is used for chamfering the outer edge portion of the first end surface 91 of the gear 9. The other of the two tools 30 is used for chamfering the outer edge portion of the second end surface 92 of the gear 9. The shapes of the two tools 30 are the same. The detailed shape of the tool 30 will be described later.

The gear driver 40 is a mechanism that rotates the gear 9 about the gear axis A. The gear driver 40 is spaced apart from the tool driver 20 in the x direction. As illustrated in FIG. 1, the gear driver 40 includes a table 41, a counter column 42, and a tail stock 43. In FIG. 2, illustration of the counter column 42 and the tail stock 43 is omitted.

The table 41 supports the gear 9 from below. The table 41 is disposed between the column 21 and the counter column 42. A lower clamper 411 that supports the gear 9 from below is provided at the upper end portion of the table 41.

The counter column 42 is fixed to the upper surface of the bed 10. The counter column 42 extends upward from the upper surface of the bed 10. The tail stock 43 is a unit that supports the gear 9 from above. The tail stock 43 is provided on a surface of the counter column 42 facing the tool driver 20 so as to be vertically movable. An upper clamper 431 that supports the gear 9 from above is provided at a lower end portion of the tail stock 43.

The gear 9 is sandwiched between the lower clamper 411 of the table 41 and the upper clamper 431 of the tail stock 43. As a result, the gear 9 is held in a posture in which the gear axis A is disposed in the vertical direction. The lower clamper 411 and the upper clamper 431 are rotatable about a rotation axis extending in the z direction by a first rotation mechanism (not illustrated). Therefore, by operating the first rotation mechanism in a state where the gear 9 is held by the lower clamper 411 and the upper clamper 431, the gear 9 can be rotated about the gear axis A extending in the z direction.

In this manner, the gear driver 40 rotates the gear 9 about the gear axis A disposed non-parallel to the tool axis B.

The changer 50 is a mechanism that conveys the gear 9. As illustrated in FIGS. 1 and 2, the changer 50 includes a turntable 51. The turntable 51 has a plurality of arms 52. The gear 9 is held at the distal end of each arm 52 via a gripper. The turntable 51 rotates about a rotation axis extending in the z direction by a second rotation mechanism (not illustrated) while holding the gear 9 in each arm 52. As a result, the gear 9 can be conveyed between a machining position P1 between the table 41 and the tail stock 43 and a standby position P2 laterally away from the machining position P1.

In the example of FIG. 2, the turntable 51 includes three arms 52. However, the number of arms 52 of the turntable 51 may be 1, 2, or 4 or more.

The phase sensor 60 is a sensor for detecting a phase (rotation angle) of rotation of the gear 9. As the phase sensor 60, for example, an optical sensor such as a laser displacement meter is used. When the gear 9 is rotated by the second rotation mechanism, the plurality of external teeth 90 of the gear 9 sequentially pass through the detection positions of the phase sensor 60. The phase sensor 60 detects the external tooth 90 passing through the detection position. As a result, the phase sensor 60 outputs a detection signal corresponding to the phase of the rotation of the gear 9.

The controller 70 is a unit for controlling the operation of each unit of the machining device 1. As the controller 70, for example, a computer having a processor 71 such as a CPU, a memory 72 such a RAM, and a storage 73 such as a hard disk. The storage 73 stores a computer program P for controlling the operation of each unit of the machining device 1.

Further, the controller 70 is communicably connected to the first drive mechanism, the second drive mechanism, the third drive mechanism, the fourth drive mechanism, the fifth drive mechanism, the first rotation mechanism, the second rotation mechanism, and the phase sensor 60 described above. The controller 70 controls the operation of these units in accordance with the computer program P described above. As a result, the processing of the gear 9 in the machining device 1 proceeds.

Note that a detailed operation procedure of the machining device 1 will be described later.

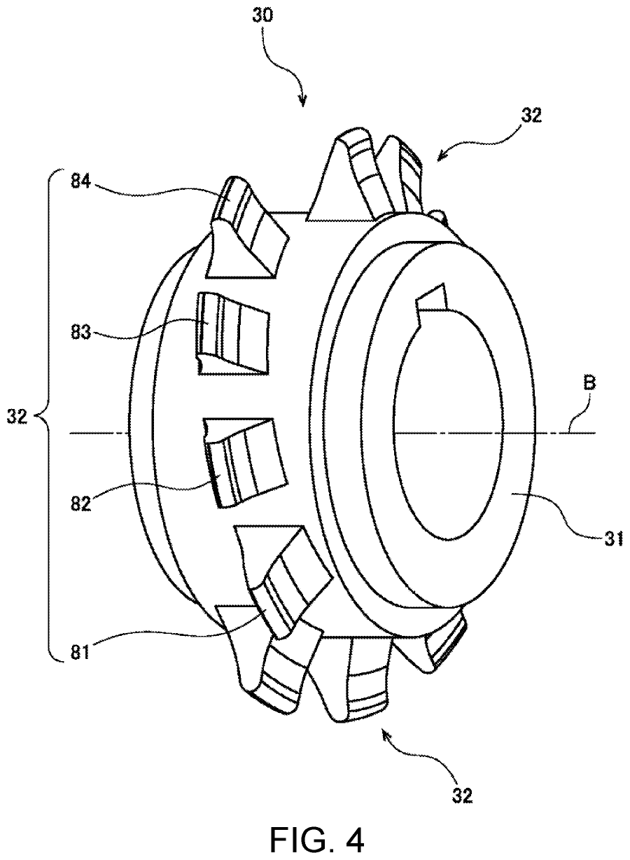

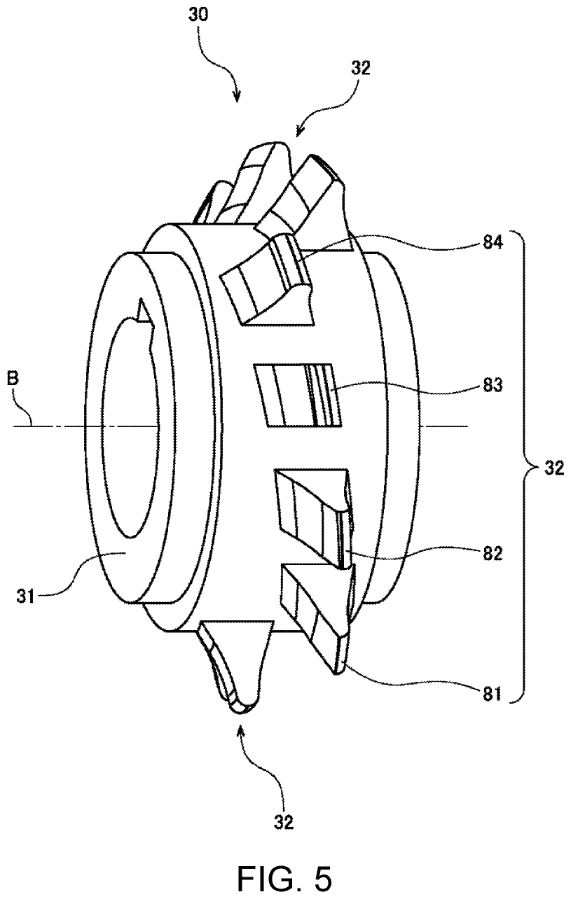

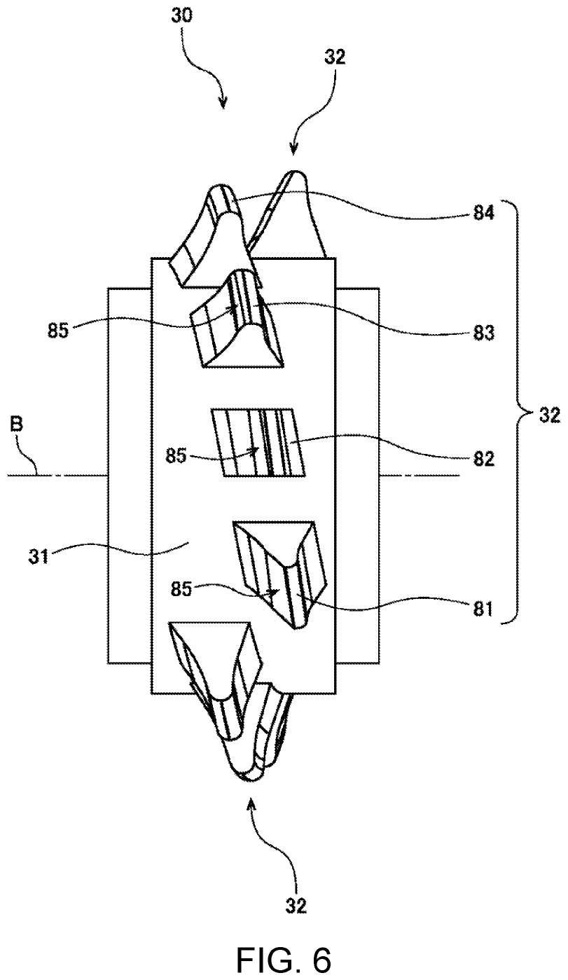

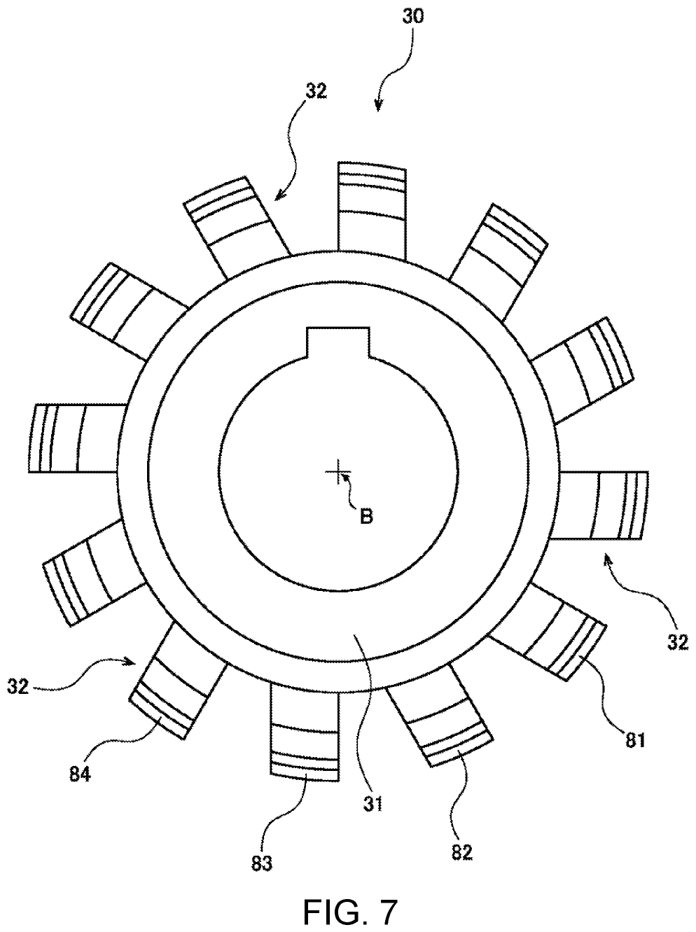

Next, a more detailed shape of the tool 30 will be described. FIGS. 4 and 5 are perspective views of the tool 30. FIG. 6 is a side view of the tool 30. FIG. 7 is a plan view of the tool 30.

As illustrated in FIGS. 4, 5, 6, and 7, the tool 30 includes a tool body 31 and a thread 32. The tool body 31 extends along the tool axis B. The tool body 31 of the present example embodiment has a cylindrical shape centered on the tool axis B. However, the tool body 31 may have another shape such as a polygonal cylindrical shape, for example.

The thread 32 is a blade for machining the gear 9. The tool 30 of the present example embodiment has a plurality of threads 32. More specifically, the tool 30 of the present example embodiment has three threads 32. However, the number of threads 32 of the tool 30 may be 1, 2, or 4 or more. In order to avoid interference with teeth other than the first tooth surface 901 or the second tooth surface 902 to be described later, the thread 32 is preferably 2 pitches or less, particularly 1 pitch in the axial direction. The center angle about the tool axis B in the circumferential direction of the tool axis B at which the thread 32 is disposed is preferably a divisor of 360 degrees. Thus, when the tool 30 makes one rotation about the tool axis B, the gear 9 can be machined without excess or deficiency.

Each thread 32 protrudes in a direction away from the tool axis B on the outer surface of the tool body 31. Each thread 32 is disposed in a spiral shape about the tool axis B. The thread 32 includes a first region 81 and a second region 82. The first region 81 and the second region 82 are formed along the spiral of the thread 32. These regions are arranged at different positions.

In the present example embodiment, the thread 32 has a first region 81, a second region 82, a third region 83, and a fourth region 84. The first region 81, the second region 82, the third region 83, and the fourth region 84 are disposed in this order along the spiral of the thread 32. Further, grooves are formed between the first region 81 and the second region 82, between the second region 82 and the third region 83, and between the third region 83 and the fourth region 84. Therefore, in the present example embodiment, the first region 81, the second region 82, the third region 83, and the fourth region 84 are disposed at intervals along the spiral of the thread 32.

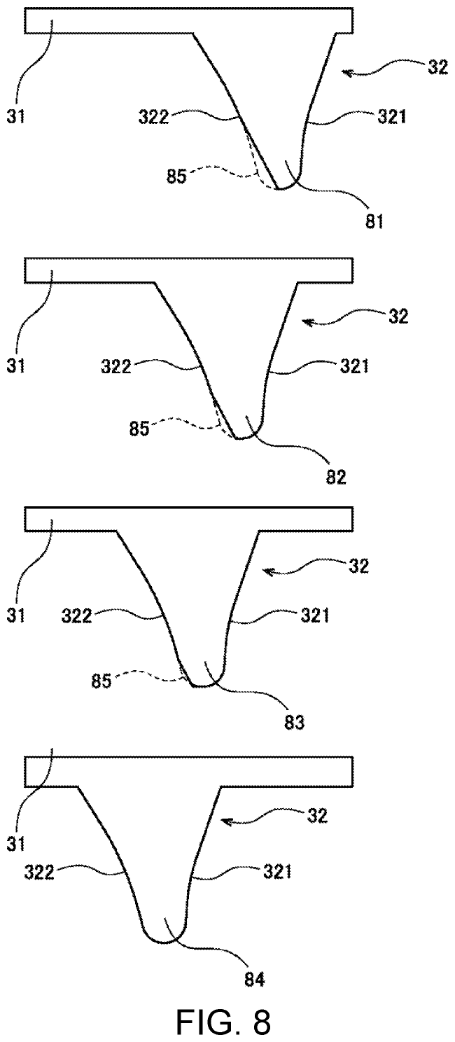

FIG. 8 is a diagram illustrating a cross-sectional shape (hereinafter referred to as a “tooth profile”) when the thread 32 is cut along a plane including the tool axis B. As illustrated in FIG. 8, the tooth profile of the thread 32 is a substantially triangular shape. Specifically, the dimension of the thread 32 in the direction parallel to the tool axis B (hereinafter referred to as “axial direction”) gradually decreases as it goes away from the tool axis B. The thread 32 has a right tooth flank 321 which is a surface on one side in the tool axis B direction and a left tooth flank 322 which is a surface on the other side in the tool axis B direction. The right tooth flank 321 is a surface on the right side of the thread 32 in FIG. 8. The left tooth flank 322 is a surface on the left side of the thread 32 in FIG. 8.

In the tool 30, the tooth profile of the thread 32 is gradually recessed from the fourth region 84 to the first region 81. That is, among the first region 81, the second region 82, the third region 83, and the fourth region 84, the maximum region where the tooth profile is the most convex is the fourth region 84. The maximum region is disposed at a position opposite to the first region 81 along the spiral of the thread 32 with reference to the second region 82. Here, the most convex tooth profile means that the cross-sectional area of the tooth profile is maximized.

In FIG. 8, the tooth profile of the fourth region 84 is illustrated by a broken line while overlapping the tooth profiles of the first region 81, the second region 82, and the third region 83. As illustrated in FIG. 8, in the first region 81, the second region 82, and the third region 83, there is a relieved portion 85 missing from the tooth profile of the fourth region 84 which is the maximum region. Therefore, the tooth profile of the third region 83 is recessed from the tooth profile of the maximum region. The tooth profile of the second region 82 is also recessed from the tooth profile of the maximum region. The tooth profile of the first region 81 is also recessed from the tooth profile of the maximum region. As a result, the gear 9 can be appropriately machined while suppressing contact between the tool 30 and the gear 9 in a plurality of regions of the thread 32.

The size of the relieved portion 85 gradually increases from the third region 83 to the first region 81. Therefore, the tooth profile of the third region 83 is recessed more than the tooth profile of the fourth region 84. The tooth profile of the second region 82 is recessed more than the tooth profile of the third region 83. The tooth profile of the first region 81 is recessed more than the tooth profile of the second region 82. As a result, the gear can be appropriately machined while suppressing the contact between the tool 30 and the gear 9 according to the principle described later.

In particular, in the present example embodiment, the relieved portion 85 is provided on the left tooth flank 322 of the thread 32. Therefore, in the present example embodiment, in the left tooth flank 322, the tooth profile of the third region 83 is recessed more than the tooth profile of the fourth region 84. On the left tooth flank 322, the tooth profile of the second region 82 is recessed more than the tooth profile of the third region 83. On the left tooth flank 322, the tooth profile of the first region 81 is recessed more than the tooth profile of the second region 82.

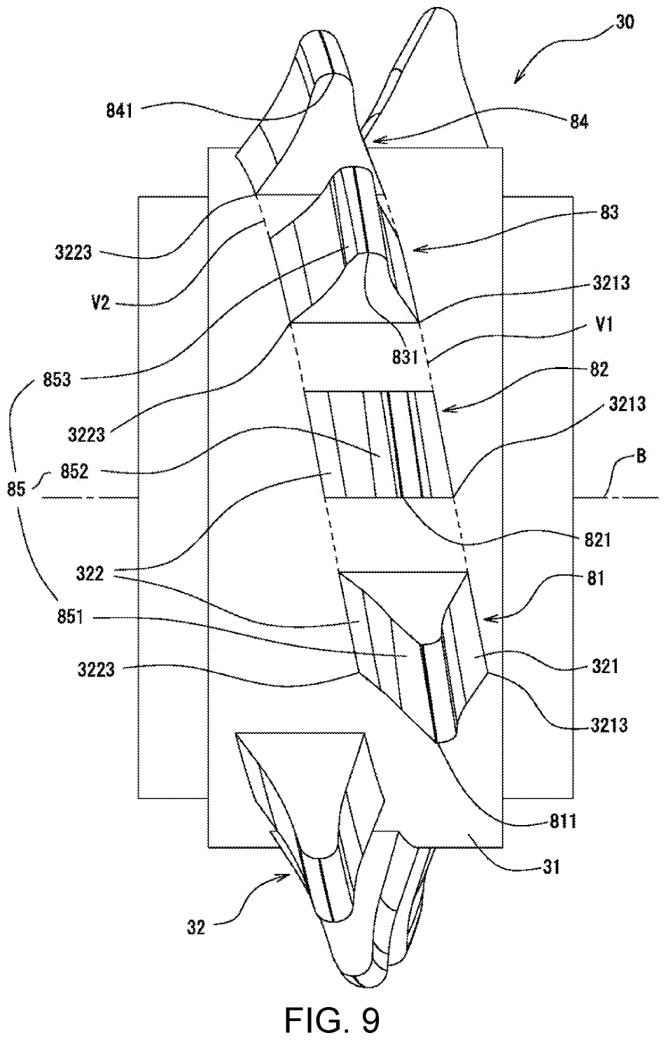

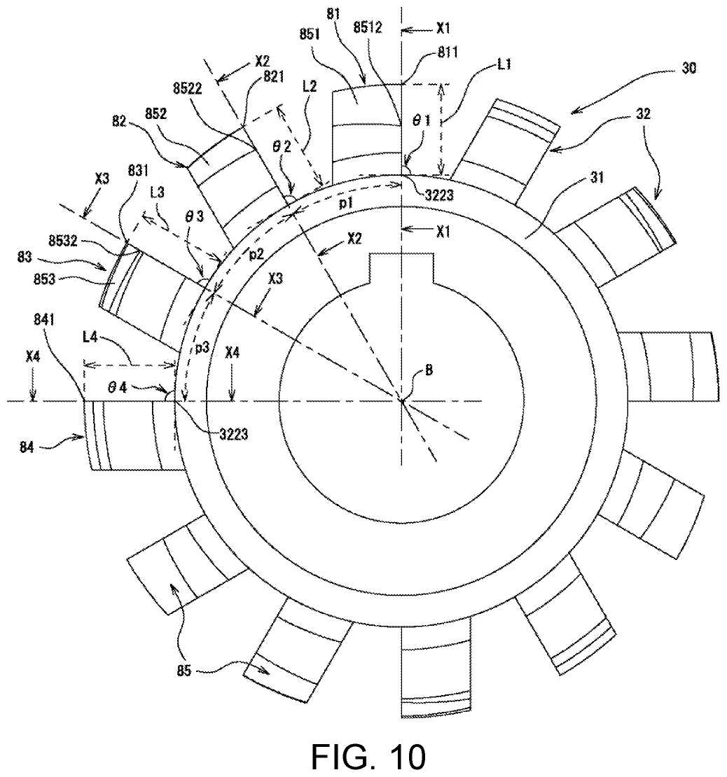

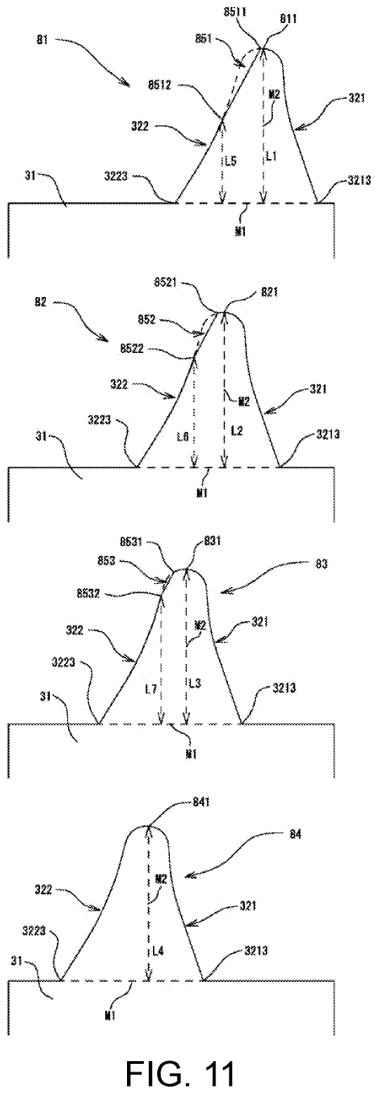

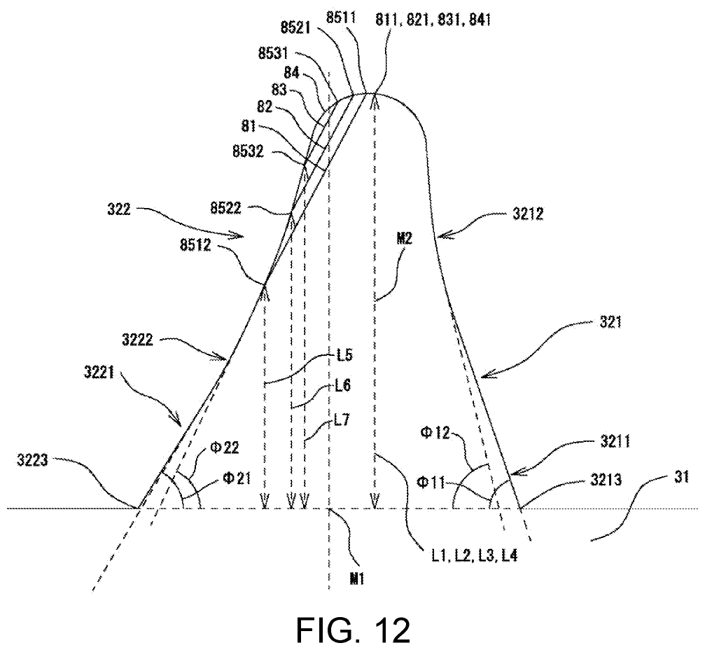

Here, the shape of the tool 30 will be described in more detail with reference to FIGS. 9 to 12. FIG. 9 is a side view of the tool 30. FIG. 10 is a bottom view of the tool 30. FIG. 11 is a diagram illustrating the tooth profile of the thread 32. FIG. 12 is a diagram in which tooth profiles of the threads 32 are overlapped.

As illustrated in FIG. 9, the tool 30 includes a tool body 31 and a thread 32. The tool body 31 extends along the tool axis B. In the present example embodiment, the tool body 31 has a substantially cylindrical shape. In the present description, three threads 32 are disposed so as to make one turn in a spiral direction around the tool axis B. However, the number of threads around the tool axis B may be other than three.

The thread 32 protrudes in a direction away from the tool axis B on the outer surface of the tool body 31. That is, the thread 32 protrudes outward in the radial direction with respect to the tool axis B on the outer surface of the tool body 31. The threads 32 are disposed spirally about the tool axis B.

In the present example embodiment, the tool 30 is a hob. Thus, the thread 32 has a plurality of independent blades disposed in a spiral shape. In the present example embodiment, the number of blades included in one thread 32 is 4, for example. That is, the thread 32 includes a first region 81, a second region 82, a third region 83, and a fourth region 84. The first region 81 is disposed on one side in the spiral direction. The second region 82 is disposed on the other side in the spiral direction with respect to the first region 81. The third region 83 is disposed on the other side in the spiral direction with respect to the second region 82. The fourth region 84 is disposed on the other side in the spiral direction with respect to the third region 83. The number of regions included in the thread may be other than four. In the present example embodiment, the fourth region 84 is a maximum region where the tooth profile of the thread 32 is maximum, and is a reference region serving as a reference of the tooth profile of the thread 32.

The first region 81 has a one-side tooth flank 321 which is a surface on one side in the tool axis B direction and an other-side tooth flank 322 which is a surface on the other side in the tool axis B direction. That is, the one-side tooth flank 321 is a blade surface seen when the other side is viewed from the one side of the tool axis B, and the other-side tooth flank 322 is a blade surface seen when the one side is viewed from the other side of the tool axis B. Similarly, the second region 82 has a one-side tooth flank 321 which is a surface on one side in the tool axis B direction and an other-side tooth flank 322 which is a surface on the other side in the tool axis B direction. The third region 83 has a one-side tooth flank 321 which is a surface on one side in the tool axis B direction and an other-side tooth flank 322 which is a surface on the other side in the tool axis B direction. The fourth region 84 has a one-side tooth flank 321 which is a surface on one side in the tool axis B direction and an other-side tooth flank 322 which is a surface on the other side in the tool axis B direction.

The one-side tooth flank 321 of each region is disposed along a spiral direction with respect to the tool axis B. Therefore, a tool axis B-side end 3213 of the one-side tooth flank 321 of the first region 81, a tool axis B-side end 3213 of the one-side tooth flank 321 of the second region 82, a tool axis B-side end 3213 of the one-side tooth flank 321 of the third region 83, and the tool axis B-side end 3213 of the one-side tooth flank 321 of the fourth region 84 are disposed in a spiral shape about the tool axis B. Here, the tool axis B-side end 3213 of the one-side tooth flank 321 is an inner end of the one-side tooth flank 321 in the radial direction with reference to the tool axis B. In other words, the tool axis B-side end 3213 of the one-side tooth flank 321 is a root of the one-side tooth flank 321. The tool axis B-side end 3213 of the one-side tooth flank 321 can also be said to be a boundary between the thread 32 and the outer surface of the tool body 31. That is, the tool axis B-side end 3213 of the one-side tooth flank 321 of the thread 32 is disposed in a spiral shape centered on the tool axis B. That is, the tool axis B-side end 3213 of the one-side tooth flank 321 of the thread 32 is arranged along a virtual line V1. The virtual line V1 is a spiral direction with respect to the tool axis B. In other words, when the outer surface of the tool body 31 is developed in the circumferential direction with respect to the tool axis B, the tool axis B-side ends 3213 of the one-side tooth flanks 321 of the thread 32 are arranged in a straight line. Thus, the workpiece can be machined with the tool axis B-side end 3213 of the one-side tooth flank 321 in a plurality of regions in the spiral direction in accordance with the shape and machining method of the workpiece. Therefore, when machining a workpiece, it is possible to suppress concentration of a load on a specific region of the one-side tooth flank 321, and chamfering can be performed in a shape along the involute by the creation motion. A state of machining the workpiece will be described later.

Similarly, a tool axis B-side end 3223 of the other-side tooth flank 322 of the first region 81, a tool axis B-side end 3223 of the other-side tooth flank 322 of the second region 82, a tool axis B-side end 3223 of the other-side tooth flank 322 of the third region 83, and a tool axis B-side end 3223 of the other-side tooth flank 321 of the fourth region 84 are disposed in a spiral shape about the tool axis B. Here, the tool axis B-side end 3223 of the other-side tooth flank 322 is an inner end of the other-side tooth flank 322 in the radial direction with reference to the tool axis B. In other words, the tool axis B-side end 3223 of the other-side tooth flank 322 is a root of the other-side tooth flank 322. It can also be said that the tool axis B-side end 3223 of the other-side tooth flank 322 is a boundary between the thread 32 and the outer surface of the tool body 31. That is, the tool axis B-side end 3223 of the other-side tooth flank 322 of the thread 32 is disposed in a spiral shape centered on the tool axis B. That is, the tool axis B-side end 3223 of the other-side tooth flank 322 of the thread 32 is arranged along a virtual line V2. The virtual line V2 is a spiral direction with respect to the tool axis B. In other words, when the outer surface of the tool body 31 is developed in the circumferential direction with respect to the tool axis B, the tool axis B-side ends 3223 of the other-side tooth flanks 322 of the thread 32 are arranged in a straight line. Thus, the workpiece can be machined at the tool axis B-side end 3223 of the other-side tooth flank 322 in a plurality of regions in the spiral direction in accordance with the shape and machining method of the workpiece. Therefore, when machining a workpiece, it is possible to suppress concentration of a load on the tool axis B-side end in a specific region of the other-side tooth flank 322, and chamfering can be performed in a shape along the involute by the creation motion.

FIG. 10 illustrates a state in which the tool 30 is viewed from the other side in the tool axis B direction toward one side in the tool axis B direction. As illustrated in FIG. 10, the tooth length of the first region 81, the tooth length of the second region 82, the tooth length of the third region 83, and the tooth length of the fourth region 84 are all equal. That is, the distance L1 between the inner end in the radial direction with reference to the tool axis B and the radially outer end on one side surface in the spiral direction of the first region 81, the distance L2 between the inner end in the radial direction with reference to the tool axis B and the radially outer end on one side surface in the spiral direction of the second region 82, the distance L3 between the inner end in the radial direction with reference to the tool axis B and the radially outer end on one side surface in the spiral direction of the third region 83, and the distance L4 between the inner end in the radial direction with reference to the tool axis B and the radially outer end on one side surface in the spiral direction of the fourth region 84 are all equal. In other words, in the radial direction with reference to the tool axis B, the lengths from the radially inner ends to the radially outer ends of the first region 81, the second region 82, the third region 83, and the fourth region 84 are all equal. Thus, the tooth bottom of the gear can be machined in both the blade surfaces of the one-side tooth flank 321 and the other-side tooth flank 322. However, in other example embodiments, the length from the radially inner end to the radially outer end in at least one region of the thread 32 may be different from the length from the radially inner end to the radially outer end in the other region. As a result, by matching the tooth length in a region that is a range necessary for machining the workpiece with the tooth length in another region and making the tooth length different in the other regions, it is possible to realize the necessary machining while avoiding unnecessary contact between the workpiece and the tool 30.

Rake angles of the first region 81, the second region 82, the third region 83, and the fourth region 84 are all equal. That is, in FIG. 10, an angle θ1 formed by one side surface in the spiral direction of the first region 81 and the outer surface of the tool body 31, an angle θ2 formed by one side surface in the spiral direction of the second region 82 and the outer surface of the tool body 31, an angle θ3 formed by one side surface in the spiral direction of the third region 83 and the outer surface of the tool body 31, and an angle θ4 formed by one side surface in the spiral direction of the fourth region 84 and the outer surface of the tool body 31 are all equal. Thus, the tool 30 can be easily manufactured. Therefore, the manufacturing efficiency of the tool 30 is improved. However, depending on the shape of the workpiece or the workpiece machining method, the rake angles in at least one or more regions may be different from the rake angles in other regions. Thus, the shape of the tool can be optimized according to the shape of the workpiece or the workpiece machining method. In the present example embodiment, the angle θ1, the angle θ2, the angle θ3, and the angle θ4 are all approximately 90 degrees. In the present example embodiment, the outer surface of the tool body 31 has a cylindrical shape with respect to the tool axis B. Therefore, one side surface of the first region 81 in the spiral direction and the tool axis B are disposed on the same plane. Similarly, one side surface of the second region 82 in the spiral direction, one side surface of the second region 82 in the spiral direction and the tool axis B, one side surface of the third region 83 in the spiral direction and the tool axis B, and one side surface of the fourth region 84 in the spiral direction and the tool axis B are disposed on virtual planes along the tool axis B.

In the present example embodiment, clearance angles of the first region 81, the second region 82, the third region 83, and the fourth region 84 are all equal. That is, the angle formed by the other side surface of the first region 81 in the spiral direction and the outer surface of the tool body 31, the angle formed by the other side surface of the second region 82 in the spiral direction and the outer surface of the tool body 31, the angle formed by the other side surface of the third region 83 in the spiral direction and the outer surface of the tool body 31, and the angle formed by the other side surface of the fourth region 84 in the spiral direction and the outer surface of the tool body 31 are all equal. As a result, the strength of all the regions can be made as uniform as possible while suppressing unnecessary contact with the workpiece in all the regions of the thread 32. However, depending on the shape of the workpiece or the workpiece machining method, the clearance angle in at least one or more regions may be different from the clearance angles in other regions. As a result, the shape of the tool can be optimized in accordance with the shape of the workpiece, the workpiece machining method, and the strength required for an arbitrary region in the thread.

In the circumferential direction with the tool axis B as a reference, a pitch P1 between the first region 81 and the second region 82, a pitch P2 between the second region 82 and the third region 83, and a pitch P3 between the third region 83 and the fourth region 84 are all equal. That is, in the circumferential direction with the tool axis B as a reference, the length between the radially inner end on one side surface of the first region 81 in the spiral direction and the radially inner end on one side surface of the second region 82 in the spiral direction, the length between the radially inner end on one side surface of the second region 82 in the spiral direction and the radially inner end on one side surface of the third region 83 in the spiral direction, and the length between the radially inner end on one side surface of the third region 83 in the spiral direction and the radially inner end on one side surface of the fourth region 84 in the spiral direction are all equal. Thus, the tool 30 can be easily manufactured. Therefore, the manufacturing efficiency of the tool 30 is improved.

FIG. 11 is a diagram in which the tooth profile of the first region 81 in the X1-X1 cross section, the tooth profile of the second region 82 in the X2-X2 cross section, the tooth profile of the third region 83 in the X3-X3 cross section, and the tooth profile of the fourth region in the X4-X4 cross section are arranged in FIG. 10. The X1-X1 cross section coincides with one side surface of the first region 81 in the spiral direction, the X2-X2 cross section coincides with one side surface of the second region 82 in the spiral direction, the X3-X3 cross section coincides with one side surface of the third region 83 in the spiral direction, and the X4-X4 cross section coincides with one side surface of the fourth region 84 in the spiral direction. That is, the X1-X2 cross section, the X2-X2 cross section, the X3-X3 cross section, and the X4-X4 cross section are a cross section intersecting the tool axis B along one side surface of the first region 81 in the spiral direction, a cross section intersecting the tool axis B along one side surface of the second region 82 in the spiral direction, a cross section intersecting the tool axis B along one side surface of the third region 83 in the spiral direction, and a cross section intersecting the tool axis B along one side surface of the fourth region 84 in the spiral direction, respectively. In the present example embodiment, one side surface in the spiral direction of each region spreads radially about the tool axis B. However, when one side surface in the spiral direction of each region extends in a direction intersecting the radial direction about the tool axis B, the tooth profile of each region may be defined by a cross section in the radial direction about the tool axis B in each region.

In FIG. 12, the tooth profile of the first region 81 in the X1-X1 cross section, the tooth profile of the second region 82 in the X2-X2 cross section, the tooth profile of the third region 83 in the X3-X3 cross section, and the tooth profile of the fourth region 84 in the X4-X4 cross section are overlapped. Referring to FIGS. 9 to 12, the first region 81, the second region 82, and the third region 83 each have the relieved portion 85. That is, the relieved portion 851 on the other side in the first region 81 is a difference in shape of the other-side tooth flank 322 when the tooth profile of the first region 81 and the tooth profile of the fourth region 84 are overlapped. In the present example embodiment, the fourth region 84 is a reference region and a maximum region. Therefore, in FIG. 11, a region surrounded by the tooth profile of the first region 81 and the tooth profile of the fourth region 84 indicated by a broken line is the relieved portion 851 on the other side. Similarly, the relieved portion 852 on the other side in the second region 82 is a difference in shape on the other-side tooth flank 322 when the tooth profile of the second region 82 and the tooth profile of the fourth region 84 are overlapped, and the relieved portion 853 on the other side in the third region 83 is a difference in shape on the other-side tooth flank 322 when the tooth profile of the third region 83 and the tooth profile of the fourth region 84 are overlapped. That is, in FIG. 11, a region surrounded by the tooth profile of the second region 82 and the tooth profile of the fourth region 84 indicated by a broken line is the relieved portion 852 on the other side in the second region 82, and a region surrounded by the tooth profile of the third region 83 and the tooth profile of the fourth region 84 indicated by a broken line is the relieved portion 853 on the other side in the third region 83.

As illustrated in FIG. 12, the shape of the one-side tooth flank 321 in the tooth profile of the first region 81 coincides with the shape of the one-side tooth flank 321 in the tooth profile of the fourth region 84. In the present example embodiment, the one-side tooth flank 321 of the first region 81, the one-side tooth flank 321 of the second region 82, the one-side tooth flank 321 of the third region 83, and the one-side tooth flank 321 of the fourth region 84 all coincide with each other. That is, the shape on one side in the tool axis B direction from a radially outer end 811 with reference to the tool axis B in the first region 81, the shape on one side in the tool axis B direction from a radially outer end 821 with reference to the tool axis B in the second region 82, the shape on one side in the tool axis B direction from a radially outer end 831 with reference to the tool axis B in the third region 83, and the shape on one side in the tool axis B direction from a radially outer end 841 with reference to the tool axis B in the fourth region 84 all coincide with each other. That is, there is no relieved portion on the one-side tooth flank 321 in each region of the thread 32. Thus, by providing the relieved portion 85 on the other-side tooth flank 322 of the thread 32 while maintaining the outline of the cutting edge necessary for the creation processing, interference between the tool 30 and the tooth surface on the non-machining side of the gear can be suppressed. This feature is particularly useful when cutting and chamfering each tooth surface of a gear by the tool 30.

The other-side tooth flank 322 in the first region 81 is recessed more than the other-side tooth flank 322 in the second region 82, the other-side tooth flank 322 in the second region 82 is recessed more than the other-side tooth flank 322 in the third region 83, and the other-side tooth flank 322 in the third region 83 is recessed more than the other-side tooth flank 322 in the fourth region 84. That is, on the other-side tooth flank 322, the tooth profile of the second region 82 is larger than the tooth profile of the first region 81, the tooth profile of the third region 83 is larger than the tooth profile of the second region 82, and the tooth profile of the fourth region 84 is larger than the tooth profile of the third region 83. The relieved portion 85 becomes wider from the third region 83 toward the first region 81. As a result, in the first region 81, while the portion of the workpiece on the tool 30 side is machined by the portion of the first region 81 on the tool axis B side, a relieved portion 851 on the other side for avoiding contact between the first region 81 and the workpiece can be widely secured. Also in the second region 82 and the third region 83, while a predetermined region of the workpiece is machined by a portion on the tool axis B side in each region, the relieved portions 852 and 853 on the other side required for avoiding contact between each region and the workpiece can be secured. Since the tooth profile of the fourth region 84 is the maximum in the thread 32, the workpiece can be machined using a portion near the radially outer end with reference to the tool axis B in the fourth region 84. Therefore, by gradually increasing the tooth profile of each of the first region 81 to the fourth region 84, it is possible to change the portion to be machined by the thread 32 radially outward with reference to the tool axis B as it goes from the first region 81 to the fourth region 84 while avoiding unnecessary contact between the thread 32 and the workpiece.

On the other-side tooth flank 322 of the thread 32, the shape of each region is different by the difference in the shape of the relieved portion 85 in each region. That is, with reference to FIG. 12, a radially outer end 8511 of the relieved portion 851 on the other side in the first region 81 is disposed on one side in the tool axis B direction with respect to a radially outer end 8521 of the relieved portion 852 on the other side in the second region 82 with respect to the tool axis B. Similarly, with reference to the tool axis B, the radially outer end 8521 of the relieved portion 852 on the other side in the second region 82 is disposed on one side in the tool axis B direction with respect to a radially outer end 8531 of the relieved portion 853 on the other side in the third region 83. However, in accordance with the shape and the machining method of the workpiece, for example, the radially outer end 8521 of the relieved portion 852 on the other side in the second region 82 may be disposed at the same position as the radially outer end 8531 of the relieved portion 853 on the other side in the third region 83 in the tool axis B direction. Similarly in other regions, the position in the tool axis B direction may be changed in accordance with the shape of the workpiece or the machining method.

On the other hand, also in the radial direction with reference to the tool axis B, the radially outer end 8511 of the relieved portion 851 on the other side in the first region 81 is disposed radially outward of the radially outer end 8521 of the relieved portion 852 on the other side in the second region 82. Similarly, the radially outer end 8521 of the relieved portion 852 on the other side in the second region 82 is disposed radially outward of the radially outer end 8531 of the relieved portion 853 on the other side in the third region 83. Thus, in the region from the first region 81 to the fourth region 84, by gradually increasing the tooth profile of each region, it is possible to change the portion to be machined by the thread 32 radially outward with reference to the tool axis as it goes from the first region 81 to the fourth region 84 while avoiding unnecessary contact between the thread 32 and the workpiece. However, in accordance with the shape and the machining method of the workpiece, for example, the radially outer end 8521 of the relieved portion 852 on the other side in the second region 82 may be disposed at the same position in the radial direction as the radially outer end 8531 of the relieved portion 853 on the other side in the third region 83. Similarly, in other regions, the radial position may be changed according to the shape of the workpiece or the machining method.

A radially inner end 8512 of the relieved portion 851 on the other side in the first region 81 is disposed radially inward of a radially inner end 8522 of the relieved portion 852 on the other side in the second region 82 and on the other side in the tool axis B direction, and the radially inner end 8522 of the relieved portion 852 on the other side in the second region 82 is disposed radially inward of a radially inner end 8532 of the relieved portion 853 on the other side in the third region 83 and on the other side in the tool axis B direction. Thus, in the region from the first region 81 to the fourth region 84, by gradually increasing the tooth profile of each region, it is possible to change the portion to be machined by the thread 32 radially outward with reference to the tool axis as it goes from the first region 81 to the fourth region 84 while avoiding unnecessary contact between the thread 32 and the workpiece. Further, the radially inner end 8512 based on the tool axis B in the relieved portion 851 on the other side of the first region 81 disposed on the tool axis side, the radially inner end 8522 based on the tool axis B in the relieved portion 852 on the other side of the second region 82, and the radially inner end 8532 based on the tool axis B in the relieved portion 853 on the other side of the third region 83 are disposed on the other side in the tool axis B direction with respect to the midpoint M1. Here, the midpoint M1 is a midpoint in the tool axis B direction between a radially inner end 3213 of the one-side tooth flank 321 of the first region 81 and a radially inner end 3223 of the other-side tooth flank 322 of the first region 81. As a result, the relieved portion 85 in each region of the thread 32 can be disposed at an appropriate position. Therefore, according to the principle described later, it is possible to machine an appropriate portion of the workpiece while avoiding unnecessary contact between the thread 32 and the workpiece. At least one of the radially outer end 8511 of the relieved portion 851 on the other side, the radially outer end 8521 of the relieved portion 852 on the other side, and the radially outer end 8531 of the relieved portion 853 on the other side may be disposed on the other side in the tool axis B direction with respect to the midpoint M1, and at least one of the radially inner end 8512 of the relieved portion 851 on the other side, the radially inner end 8522 of the relieved portion 852 on the other side, and the radially inner end 8532 of the relieved portion 853 on the other side may be disposed on one side in the tool axis B direction with respect to the midpoint M1. As a result, the shape of the thread 32 can be optimized in accordance with the shape and the machining method of the workpiece.

When a radial midpoint between a line connecting the radially inner end 3213 of the one-side tooth flank 321 of the first region 81 and the radially inner end 3223 of the one-side tooth flank 322 of the first region 81 and the radially outer end 811 of the first region 81 is M2, the radially inner end 8512 of the relieved portion 851 on the other side of the first region 81, the radially inner end 8522 of the relieved portion 852 on the other side of the second region 82, and the radially inner end 8532 of the relieved portion 853 on the other side of the third region 83 are disposed radially outward of the midpoint M2. That is, the relieved portion 85 is disposed radially outward of the midpoint M2. In other words, the shape of the other-side tooth flank 322 of the first region 81, the shape of the other-side tooth flank 322 of the second region 82, and the shape of the other-side tooth flank 322 of the third region 83 coincide with each other radially inward of the radially inner end 8512 of the relieved portion 851 on the second side of the first region 81, that is, radially inward of the midpoint M2. As a result, the workpiece can be machined using the other-side tooth flank 322 in an arbitrary region of the thread 32 according to the shape of the workpiece and the region to be machined. At least one of the radially inner end 8512 of the relieved portion 851 on the other side of the first region 81, the radially inner end 8522 of the relieved portion 852 on the other side of the second region 82, and the radially inner end 8532 of the relieved portion 853 on the other side of the third region 83 may be disposed radially inward of the midpoint M2.

The one-side tooth flank 321 in the first region 81, the one-side tooth flank 321 in the second region 82, the one-side tooth flank 321 in the third region 83, and the one-side tooth flank 321 in the fourth region 84 are recessed in the other side in the tool axis B direction and in the direction toward the tool axis B. The one-side tooth flank 321 of the thread 32 has an inner region 3211 of the one-side tooth flank 321 disposed radially inward with respect to the tool axis B, and an outer region 3212 disposed radially outward with respect to the tool axis B. That is, the inner region 3211 is a region disposed on the tool axis B side, and the outer region 3212 is a region disposed in a direction farther from the tool axis B than the inner region 3211 of the one-side tooth flank 321. In the present example embodiment, the angle between the one-side tooth flank 321 and the outer surface of the tool body 31 monotonously increases with distance from the tool axis B. Therefore, in the one-side tooth flank 321 of the tooth profile of the fourth region 84, the angle Φ11 between the inner region 3211 and the outer surface of the tool body 31 is smaller than the angle Φ12 between the outer region 3212 and the outer surface of the tool body 31. As a result, the workpiece can be appropriately machined while suppressing unnecessary contact between the inner region 3211 of the one-side tooth flank 321 and the workpiece. In particular, the shape is useful for cutting and chamfering a gear as an example of machining a workpiece. That is, in the normal gear cutting process, since the direction of the tooth groove and the direction of the thread of the workpiece are made to coincide with each other, it is possible to obtain an involute workpiece tooth profile by using a tooth profile in which the one-side tooth flank extends linearly. On the other hand, in the cutting and chamfering, it is necessary to perform the chamfering in a state in which the direction of the tooth groove and the direction of the thread do not coincide with each other. Therefore, an involute chamfered shape cannot be obtained in a thread having a tooth profile in which the entire one-side tooth flank extends linearly, and this tendency becomes remarkable when the length of the thread is short such as one turn. In this regard, in the present example embodiment, since the one-side tooth flank 321 has the above configuration, an involute chamfered shape can be obtained. At least one of the one-side tooth flank 321 in the first region 81, the one-side tooth flank 321 in the second region 82, the one-side tooth flank 321 in the third region 83, and the one-side tooth flank 321 in the fourth region 84 may be recessed in the other side in the tool axis B direction and in the direction toward the tool axis B in accordance with the shape and the machining method of the workpiece. In addition, the expression that the angle monotonically increases includes a case where at least a part of the tooth profile of the one-side tooth flank 321 is described linearly, and the angle of the portion is constant. That is, it is sufficient that the angle between the one-side tooth flank 321 and the outer surface of the tool body 31 does not decrease as the distance from the tool axis B increases.

In the present example embodiment, the profile of the one-side tooth flank 321 in the tooth profile of the first region 81, the profile of the one-side tooth flank 321 in the tooth profile of the second region 82, the shape of the one-side tooth flank 321 in the tooth profile of the third region 83, and the shape of the one-side tooth flank 321 in the tooth profile of the fourth region 84 coincide with each other. As a result, the workpiece can be machined by any portion of the one-side tooth flank 321 of each region. That is, by providing the relieved portion 85 on the other-side tooth flank 322, the workpiece can be machined by the other-side tooth flank 322 in an optimal region according to the shape and machining method of the workpiece, while the target region of the workpiece can be machined by the entire region of the one-side tooth flank 321.

The other-side tooth flank 322 in the first region 81, the other-side tooth flank 322 in the second region 82, the other-side tooth flank 322 in the third region 83, and the other-side tooth flank 322 in the fourth region 84 are recessed in one side in the tool axis B direction and in the direction toward the tool axis B. The shape of the recess in the tooth profile of the first region 81, the shape of the recess in the tooth profile of the second region 82, the shape of the recess in the tooth profile of the third region 83, and the shape of the recess in the tooth profile of the fourth region 84 coincide with each other. The other-side tooth flank 322 of the thread 32 has an inner region 3221 of the other-side tooth flank 322 disposed radially inward with respect to the tool axis B and an outer region 3222 disposed radially outward with respect to the tool axis B. That is, the inner region 3221 is a region disposed on the tool axis B side, and the outer region 3222 is a region disposed in a direction farther from the tool axis B than the inner region 3221. In the present example embodiment, the angle between the other-side tooth flank 322 and the outer surface of the tool body 31 monotonously increases with distance from the tool axis B. Therefore, in the other-side tooth flank 322 of the tooth profile of the fourth region 84, the angle Φ21 between the inner region 3221 and the outer surface of the tool body 31 is smaller than the angle Φ22 between the outer region 3222 and the outer surface of the tool body 31. As a result, the workpiece can be appropriately machined while suppressing unnecessary contact between the inner region 3221 of the other-side tooth flank 322 and the workpiece according to the principle described later. In particular, the shape is useful for cutting and chamfering a gear as an example of machining a workpiece. That is, in the normal gear cutting process, since the direction of the tooth groove and the direction of the thread of the workpiece are made to coincide with each other, it is possible to obtain an involute workpiece tooth profile by using a tooth profile in which the other-side tooth flank extends linearly. On the other hand, in the cutting and chamfering, it is necessary to perform the chamfering in a state in which the direction of the tooth groove and the direction of the thread do not coincide with each other. Therefore, an involute chamfered shape cannot be obtained in a thread having a tooth profile in which the entire other-side tooth flank extends linearly, and this tendency becomes remarkable when the length of the thread is short such as one turn. In this regard, in the present example embodiment, since the other-side tooth flank 322 has the above configuration, an involute chamfered shape can be obtained. At least one of the other-side tooth flank 322 in the first region 81, the other-side tooth flank 322 in the second region 82, the other-side tooth flank 322 in the third region 83, and the other-side tooth flank 322 in the fourth region 84 may be recessed in the other side in the tool axis B direction and in the direction toward the tool axis B in accordance with the shape and the machining method of the workpiece. In addition, the expression that the angle monotonically increases includes a case where at least a portion of the tooth profile of the other-side tooth flank 322 is described linearly, and the angle of the portion is constant. That is, it is sufficient that the angle between the other-side tooth flank 322 and the outer surface of the tool body 31 does not decrease as the distance from the tool axis B increases. In the present example embodiment, both the one-side tooth flank 321 and the other-side tooth flank 322 have a recessed shape, but only one of the one-side tooth flank 321 and the other-side tooth flank 322 may have a recessed shape.

In the present example embodiment, in the tooth profile of each region, the shapes of the inner region 3211 and the outer region 3212 in the one-side tooth flank 321 are left-right asymmetric with the shapes of the inner region 3221 and the outer region 3222 in the other-side tooth flank 322. That is, the angles of Φ11 and Φ21 are different, and the angles of Φ12 and Φ22 are also different. In the chamfering, since it is necessary to perform the chamfering in a state where the direction of the tooth groove and the direction of the thread 32 do not coincide with each other as described above, it is necessary to obtain a left-right asymmetric tooth profile in order to obtain a uniform chamfered shape on the left and right tooth surfaces of the workpiece. In the present example embodiment, with the above-described configuration, a uniform chamfered shape can be realized on the left and right tooth surfaces of the gear serving as the workpiece.

In the radial direction with reference to the tool axis B, the radially inner end 8512 of the relieved portion 851 on the other side in the first region 81 is disposed radially inward of the radially inner end 8522 of the relieved portion 852 on the other side in the second region 82. Similarly, the radially inner end 8522 of the relieved portion 852 on the other side in the second region 82 is disposed radially inward of the radially inner end 8532 of the relieved portion 853 on the other side in the third region 83. That is, with reference to the line connecting the radially inner end 3213 of the one-side tooth flank 321 of the first region 81 and the radially inner end 3223 of the one-side tooth flank 322 of the first region 81, the distance L5 to the radially inner end 8512 of the relieved portion 851 on the other side in the first region 81 is shorter than the distance L6 to the radially inner end 8522 of the relieved portion 852 on the other side in the second region 82, and the distance L6 to the radially inner end 8522 of the relieved portion 852 on the other side in the second region 82 is shorter than the distance L7 to the radially inner end 8532 of the relieved portion 853 on the other side in the third region 83. Thus, in the region from the first region 81 to the fourth region 84, by gradually increasing the tooth profile of each region, it is possible to change the portion to be machined by the thread 32 radially outward with reference to the tool axis as it goes from the first region 81 to the fourth region 84 while avoiding unnecessary contact between the thread 32 and the workpiece.

In the present example embodiment, when the tooth profile of the first region 81, the tooth profile of the second region 82, and the tooth profiles of the third region 83 and the fourth region 84 are overlapped, in the other-side tooth flank 322, the entire relieved portion 852 on the second side in the second region 82 overlaps the relieved portion 851 on the second side in the first region 81, and the entire relieved portion 853 on the other side in the third region 83 overlaps the relieved portion 852 on the other side in the second region 82. That is, the relieved portion 852 on the other side does not protrude from the relieved portion 851 on the other side, and the relieved portion 853 on the other side does not protrude from the relieved portion 852 on the other side. In other words, when the tooth profile of the first region 81 and the tooth profile of the second region 82 are overlapped, the tooth profile of the first region 81 does not protrude from the tooth profile of the second region. Similarly, when the tooth profile of the second region 82 and the tooth profile of the third region 83 overlap each other, the tooth profile of the second region 82 does not protrude from the tooth profile of the third region. When the tooth profile of the third region 83 and the tooth profile of the fourth region 84 overlap each other, the tooth profile of the third region 83 does not protrude from the tooth profile of the fourth region. Therefore, when the tooth profile of the first region 81, the tooth profile of the second region 82, the tooth profile of the third region 83, and the tooth profile of the fourth region 84 are overlapped, the entire relieved portion 851 on the other side of the first region 81, the entire relieved portion 852 on the other side of the second region 82, and the entire relieved portion 853 on the other side of the third region 83 are included in the tooth profile of the fourth region 84. That is, the relieved portion 851 on the other side of the first region 81, the relieved portion 852 on the other side of the second region 82, and the relieved portion 853 on the other side of the third region 83 do not protrude from the tooth profile of the fourth region 84. As a result, since the tooth profile can be gradually increased from the first region 81 to the fourth region 84, when the workpiece is machined by the tool 30, the workpiece can be machined in a portion of the first region 81 on the tool axis B side while suppressing unnecessary contact with the workpiece by reducing the tooth profile in the first region 81. Similarly, the tooth profile is gradually increased toward the second region 82, the third region 83, and the fourth region 84, and the portion contributing to machining can be changed in a direction away from the tool axis B while suppressing unnecessary contact with the workpiece.

The radially outer end portion of the thread 32 with respect to the tool axis B is a protrusion protruding radially outward and toward one side in the tool axis B direction. More specifically, with reference to the tool axis B, the radially outer end portion of the first region 81 is a protrusion that protrudes radially outward and extends radially inward toward both sides in the tool axis B direction. Similarly, with reference to the tool axis B, the radially outer end portion of the second region 82 is a protrusion that protrudes radially outward and extends radially inward toward both sides in the tool axis B direction. Similarly, with reference to the tool axis B, the radially outer end portion of the third region 83 is a protrusion that protrudes radially outward and extends radially inward toward both sides in the tool axis B direction. Similarly, with reference to the tool axis B, the radially outer end portion of the fourth region 84 is a protrusion that protrudes radially outward and extends radially inward toward both sides in the tool axis B direction. As a result, when the workpiece is machined by the tool 30, it is possible to suppress unnecessary contact with the workpiece on both sides of the radially outer end portion of the thread 32 in the tool axis B direction as compared with the case where the radially outer end portion of the thread 32 extends parallel to the tool axis B.

In the present example embodiment, the tool axis side end 3213 of the one-side tooth flank 321, the tool axis B-side end 3223 of the other-side tooth flank 322, and the radially outer end 811 with reference to the tool axis B in the tooth profile of the first region 81 coincide with the tool axis B-side end 3213 of the one-side tooth flank 321, the tool axis B-side end 3223 of the other-side tooth flank 322, and the radially outer end 821 with reference to the tool axis B in the tooth profile of the second region 82, respectively. Similarly, the tool axis side end 3213 of the one-side tooth flank 321, the tool axis B-side end 3223 of the other-side tooth flank 322, the radially outer end 831 with reference to the tool axis B in the tooth profile in the third region 83, and the tool axis side end 3213 of the one-side tooth flank 321, the tool axis B-side end 3223 of the other-side tooth flank 322, and the radially outer end 841 with reference to the tool axis B in the tooth profile in the fourth region 84 coincide with the tool axis side end 3213 of the one-side tooth flank 321, the tool axis B-side end 3223 of the other-side tooth flank 322, and the radially outer end 811 with reference to the tool axis B in the tooth profile in the first region 81. Therefore, for example, when the tooth profile of the first region 81 and the tooth profile of the fourth region 84 are overlapped, the tool axis side end 3213 of the one-side tooth flank 321, the tool axis side end 3223 of the other-side tooth flank 322, and the radially outer end 811 with reference to the tool axis B in the tooth profile of the first region 81 coincide with the tool axis side end 3213 of the one-side tooth flank 321, the tool axis side end 3223 of the other-side tooth flank 322, and the radially outer end 841 with reference to the tool axis B in the tooth profile of the fourth region 84, respectively. That is, the radially inner ends and the radially outer ends of the tooth profiles of the first region 81 to the fourth region 84 all coincide with each other. Thus, the workpiece can be machined by the vicinity of the radially inner end and the vicinity of the radially outer end of the entire region of the thread 32.

In the tool 30, the tool body 31 and the thread 32 are molded as an integrated member. That is, the tool 30 is not configured by assembling a tool body and a thread which are molded as separate portions. As a result, mass productivity of the tool 30 is improved, and rigidity is also improved. In addition, the tool 30 is particularly useful when an external gear is employed as a workpiece and both tooth surfaces of the gear are cut and chamfered separately. Further, since the tool 30 has the relieved portion 85, it is possible to machine tooth surfaces on both sides of the gear using one tool 30.

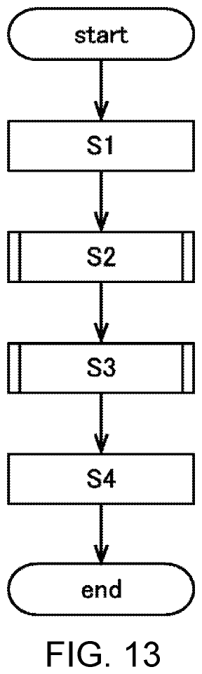

Next, the operation of the machining device 1 will be described. FIG. 13 is a flowchart illustrating a flow of operation of the machining device 1. The operation of FIG. 13 is realized by the controller 70 controlling the first drive mechanism, the second drive mechanism, the third drive mechanism, the fourth drive mechanism, the fifth drive mechanism, the first rotation mechanism, the second rotation mechanism, and the phase sensor 60 according to the computer program P.

The machining device 1 first loads the gear 9 into the machining position P1 (step S1). Specifically, the machining device 1 loads the gear 9 from the standby position P2 to the machining position P1 by the changer 50. Then, the machining device 1 holds the gear 9 by the lower clamper 411 and the upper clamper 431.

Next, the machining device 1 chamfers the outer edge portion of the first end surface 91 of the gear 9 with one of the two tools 30 (step S2). Subsequently, the machining device 1 chamfers the outer edge portion of the second end surface 92 of the gear 9 with the other of the two tools 30 (step S3).

Thereafter, the machining device 1 takes out the gear 9 from the machining position P1 (step S4). Specifically, the machining device 1 releases the holding of the gear 9 by the lower clamper 411 and the upper clamper 431. Then, the machining device 1 causes the changer 50 to unload the gear 9 from the machining position P1 to the standby position P2.

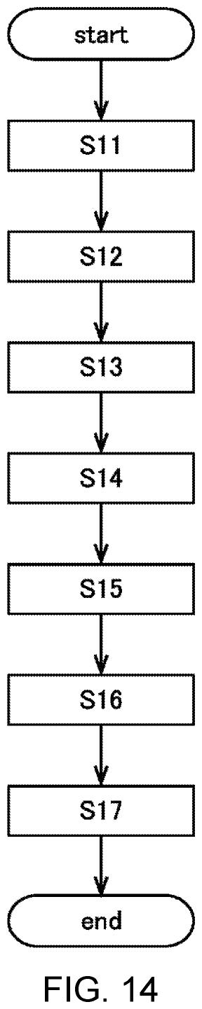

In steps S2 and S3 described above, although the place to be machined of the gear 9 is different, the procedure of the machining process itself is equivalent. FIG. 14 is a flowchart illustrating a flow of the processing in step S2 or step S3.

The machining device 1 causes the tool 30 to approach the gear 9 by the first drive mechanism, the second drive mechanism, and the third drive mechanism. Then, the machining device 1 adjusts the angle of the tool axis B to an angle suitable for machining the first tooth surface 901 by the fifth drive mechanism (step S11).

Next, the machining device 1 starts rotation of the gear 9 by the second rotation mechanism. Then, the machining device 1 detects the phase of rotation of the gear 9 by the phase sensor 60. In addition, the machining device 1 starts rotation of the tool 30 by the fourth drive mechanism. At this time, the controller 70 controls the rotation of the tool 30 based on the detection signal of the phase sensor 60. As a result, the phase of rotation of the tool 30 is matched with the phase of rotation of the gear 9 (step S12).

Specifically, assuming that the number of teeth of the gear 9 is N and the number of threads 32 of the tool 30 is M, the controller 70 rotates the tool 30 at an angular velocity of N/M times the gear 9. Then, in the next step S13, the tool 30 is rotated in a phase in which the right tooth flank 321 of the thread 32 comes into contact with the first tooth surface 901 of the external tooth 90.

Subsequently, the machining device 1 moves the tool 30 in the x direction by the first drive mechanism. Then, the right tooth flank 321 of the thread 32 comes into contact with the first tooth surface 901 of the external tooth 90. As a result, the first tooth surface 901 of the external tooth 90 is chamfered at the outer edge portion of the first end surface 91 or the outer edge portion of the second end surface 92 of the gear 9 (step S13).

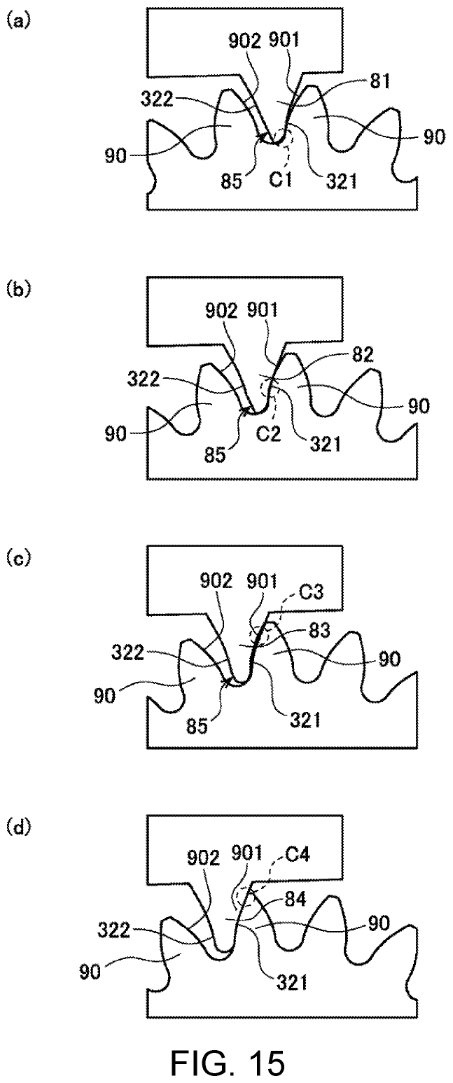

FIG. 15 is a diagram illustrating a state of processing in step S13. In FIG. 15, the first end surface 91 of the gear 9 and the cross section of the tool 30 are shown. FIG. 15 illustrates a state in which the first tooth surface 901 of one external tooth 90 is machined by one thread 32.

First, as illustrated in FIG. 15A, the right tooth flank 321 of the first region 81 machines a tooth bottom portion (a portion indicated by a dashed circle C1 in FIG. 15A) of the first tooth surface 901 of the external tooth 90. That is, the right tooth flank 321 of the first region 81 machines the tooth bottom portion of the surface of the external tooth 90 on one side in the circumferential direction of the gear axis A. At this time, the relieved portion 85 is provided on the left tooth flank 322 of the first region 81. Therefore, on the left tooth flank 322, the tooth profile of the first region 81 is recessed more than the tooth profile of the second region 82. As a result, it is possible to prevent the left tooth flank 322 of the first region 81 from coming into contact with the adjacent external tooth 90.

In particular, the distance between the adjacent external teeth 90 is narrower in the vicinity of the tooth bottom portion than in the vicinity of the tooth tip portion. Therefore, if there is no relieved portion 85 and the tooth profiles of the first region 81, the second region 82, the third region 83, and the fourth region 84 are the same, it is difficult to prevent the left tooth flank 322 of the first region 81 from contacting the adjacent external tooth 90 during processing of the tooth bottom portion of the first tooth surface 901. However, in the tool 30, the relieved portion 85 is provided on the left tooth flank 322 of the thread 32. As a result, in a narrow space near the tooth bottom portion, it is possible to prevent the left tooth flank 322 from coming into contact with the adjacent external tooth 90 while processing the first tooth surface 901 with the right tooth flank 321.

Next, as illustrated in FIG. 15B, a first intermediate portion (a portion indicated by a broken line circle C2 in FIG. 15B) of the right tooth flank 321 of the second region 82 on the tooth tip side with respect to the tooth bottom portion of the first tooth surface 901 of the external tooth 90 is machined. That is, the right tooth flank 321 of the second region 82 machines the tooth tip side with respect to the tooth bottom portion in the surface of the external tooth 90 on one side in the circumferential direction of the gear axis A. At this time, the relieved portion 85 is provided on the left tooth flank 322 of the second region 82. Therefore, on the left tooth flank 322, the tooth profile of the second region 82 is recessed more than the tooth profile of the third region 83. As a result, it is possible to prevent the left tooth flank 322 of the second region 82 from coming into contact with the adjacent external tooth 90.

Next, as illustrated in FIG. 15C, a second intermediate portion (a portion indicated by a broken line circle C3 in FIG. 15C) of the right tooth flank 321 of the third region 83 on the tooth tip side of the first intermediate portion of the first tooth surface 901 of the external tooth 90 is machined. That is, the right tooth flank 321 of the third region 83 machines the tooth tip side of the first intermediate portion in the surface of the external tooth 90 on one side in the circumferential direction of the gear axis A. At this time, the relieved portion 85 is provided on the left tooth flank 322 of the third region 83. Therefore, on the left tooth flank 322, the tooth profile of the third region 83 is recessed more than the tooth profile of the fourth region 84. As a result, it is possible to prevent the left tooth flank 322 of the third region 83 from coming into contact with the adjacent external tooth 90.

Next, as illustrated in FIG. 15D, the right tooth flank 321 of the fourth region 84 machines the tooth tip portion of the first tooth surface 901 of the external tooth 90 (a portion indicated by a dashed circle C4 in FIG. 15D). That is, the right tooth flank 321 of the fourth region 84 machines the tooth tip portion in the surface of the external tooth 90 on one side in the circumferential direction of the gear axis A. At this time, the left tooth flank 322 of the fourth region 84 has no relieved portion 85. However, at the time of machining the tooth tip portion, the distance between the left tooth flank 322 and the adjacent external tooth 90 increases. Therefore, the left tooth flank 322 of the fourth region 84 does not contact the adjacent external tooth 90.

The machining device 1 machines the first tooth surfaces 901 of all the external teeth 90 of the gear 9 by repeating such machining of FIGS. 15A, 15B, 15C, and 15D.

When the machining of the first tooth surface 901 is completed, the machining device 1 temporarily separates the tool 30 from the gear 9 by the first drive mechanism. Subsequently, the machining device 1 adjusts the angle of the tool axis B to an angle suitable for machining the second tooth surface 902 by the fifth drive mechanism (step S14). In addition, the controller 70 controls the rotation of the tool 30 based on the detection signal of the phase sensor 60. As a result, the phase of rotation of the tool 30 is matched with the phase of rotation of the gear 9 (step S15). Specifically, in the next step S16, the tool 30 is rotated in a phase in which the left tooth flank 322 of the tool 30 comes into contact with the second tooth surface 902 of the external tooth 90.

Subsequently, the machining device 1 causes the tool 30 to approach the gear 9 again by the first drive mechanism. Then, the left tooth flank 322 of the thread 32 comes into contact with the second tooth surface 902 of the external tooth 90. As a result, the second tooth surface 902 of the external tooth 90 is chamfered at the outer edge portion of the first end surface 91 or the outer edge portion of the second end surface 92 of the gear 9 (step S16).

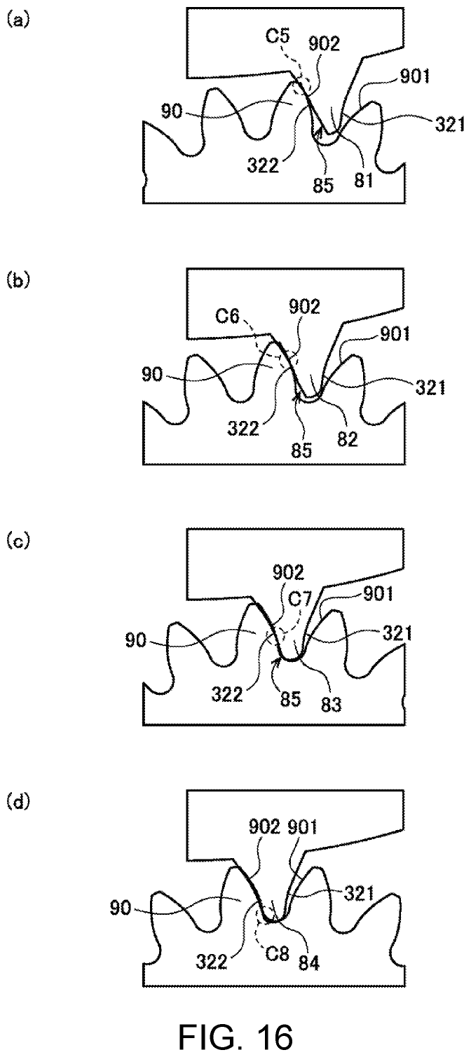

FIG. 16 is a diagram illustrating a state of processing in step S16. In FIG. 16, the first end surface 91 of the gear 9 and the cross section of the tool 30 are shown. FIG. 16 illustrates a state in which one thread 32 machines the second tooth surface 902 of one external tooth 90.

First, as illustrated in FIG. 16A, the left tooth flank 322 of the first region 81 machines a tooth tip portion (a portion indicated by a dashed circle C5 in FIG. 16A) of the second tooth surface 902 of the external tooth 90. That is, the left tooth flank 322 of the first region 81 machines the tooth tip portion in the surface of the external tooth 90 on another side in the circumferential direction of the gear axis A.

The relieved portion 85 is provided on the left tooth flank 322 of the first region 81. However, the relieved portion 85 is in a portion of the left tooth flank 322 that is not in contact with the second tooth surface 902 of the external tooth 90. That is, in the left tooth flank 322, there is the relieved portion 85 missing from the tooth profile of the maximum region in the portion of the external tooth 90 not in contact with the surface on the other side in the circumferential direction of the gear axis A. In this manner, the relieved portion 85 is provided in a portion of the second tooth surface 902 that does not contribute to machining of the tooth tip portion. Therefore, the tooth tip portion of the second tooth surface 902 of the external tooth 90 can be appropriately machined by the left tooth flank 322 of the first region 81.

Next, as illustrated in FIG. 16B, a third intermediate portion (a portion indicated by a broken line circle C6 in FIG. 16B) of the left tooth flank 322 of the second region 82 on the tooth bottom side with respect to the tooth tip portion of the second tooth surface 902 of the external tooth 90 is machined. That is, the left tooth flank 322 of the second region 82 machines the tooth bottom side with respect to the tooth tip portion in the surface of the external tooth 90 on the other side in the circumferential direction of the gear axis A.

The relieved portion 85 is also provided on the left tooth flank 322 of the second region 82. However, the relieved portion 85 is in a portion of the left tooth flank 322 that is not in contact with the second tooth surface 902 of the external tooth 90. Therefore, the third intermediate portion of the second tooth surface 902 of the external tooth 90 can be appropriately machined by the left tooth flank 322 of the second region 82.

Next, as illustrated in FIG. 16C, a fourth intermediate portion (a portion indicated by a broken line circle C7 in FIG. 16C) of the left tooth flank 322 of the third region 83 on the tooth bottom side with respect to the third intermediate portion of the second tooth surface 902 of the external tooth 90 is machined. That is, the left tooth flank 322 of the third region 83 machines the tooth bottom side with respect to the third intermediate portion in the surface of the external tooth 90 on the other side in the circumferential direction of the gear axis A.

The relieved portion 85 is also provided on the left tooth flank 322 of the third region 83. However, the relieved portion 85 is in a portion of the left tooth flank 322 that is not in contact with the second tooth surface 902 of the external tooth 90. Therefore, the fourth intermediate portion of the second tooth surface 902 of the external tooth 90 can be appropriately machined by the left tooth flank 322 of the third region 83.

Next, as illustrated in FIG. 16D, the left tooth flank 322 of the fourth region 84 machines the tooth bottom portion (a portion indicated by a dashed circle C8 in FIG. 16D) of the second tooth surface 902 of the external tooth 90. That is, the left tooth flank 322 of the fourth region 84 machines the tooth bottom portion of the surface of the external tooth 90 on the other side in the circumferential direction of the gear axis A. The left tooth flank 322 of the fourth region 84 has no relieved portion 85. Therefore, the left tooth flank 322 of the fourth region 84 can appropriately machine the tooth bottom portion of the second tooth surface 902 of the external tooth 90.

When the machining of the second tooth surface 902 is completed, the fourth drive mechanism of the tool driver 20 delays or advances the phase of rotation of the tool 30 while rotating the tool 30, thus shifting the phase of rotation of the tool 30 with respect to the rotation of the gear 9.

At this time, the phase of rotation of the tool 30 and the phase of rotation of the gear 9 change while the distal end of the thread 32 is in contact with the tooth bottom of the gear 9. As a result, the tooth bottom is smoothly chamfered at the outer edge portion of the first end surface 91 or the outer edge portion of the second end surface 92 of the gear 9 (step S17).

In step S17 described above, the first rotation mechanism of the gear driver 40 may shift the phase of rotation of the tool 30 with respect to the rotation of the gear 9 by delaying or advancing the phase of rotation of the gear 9. In step S17 described above, the relative position of the tool 30 with respect to the gear 9 may be shifted in a direction intersecting the gear axis A without shifting the phase of rotation, so that the distal end of the thread 32 may come into contact with the tooth bottom of the gear 9.

That is, after the thread 32 machines the surface on one side in the circumferential direction of the external tooth 90, the tool driver 20 or the gear driver 40 shifts the phase of rotation of the tool 30 with respect to the rotation of the gear 9, or shifts the relative position between the tool 30 and the gear 9 in the direction intersecting the gear axis A, so that the thread 32 may machine the tooth bottom of the gear 9. As a result, the tooth bottom of the gear 9 can be smoothly machined.

In particular, when machining a helical gear, since the tool 30 is inclined in the direction of the helical gear when machining the tooth surface on the obtuse angle side, the gap between the thread and the tooth surface on the opposite side (the tooth surface on the acute angle side when machining the obtuse angle side tooth surface) becomes wide, it is reasonable to machine the tooth bottom immediately after machining the tooth surface on the obtuse angle side. However, if the gap between the thread and the tooth surface of the gear is sufficient even after machining the tooth surface on the acute angle side, step S17 may be executed between step S13 and step S14.

As described above, in the tool 30 of the present example embodiment, the tooth profile of the first region 81 is different from the tooth profile of the second region 82. Accordingly, when the external teeth 90 of the gear 9 are machined, the thread 32 can be prevented from contacting the adjacent external teeth 90. Therefore, for example, it is easy to machine both the first tooth surface 901 and the second tooth surface 902 of the external tooth 90 of the gear 9 with one tool 30.

By using the tool 30 of the present example embodiment, it is possible to perform chamfering with high quality and productivity while suppressing secondary burrs. In particular, the tool of the present example embodiment is particularly useful for a helical gear having a large helix angle or a shaft-shaped gear in which a shaft exists near a tooth bottom.

While an example embodiment of the present disclosure has been described above, the present disclosure is not limited to the above example embodiment.

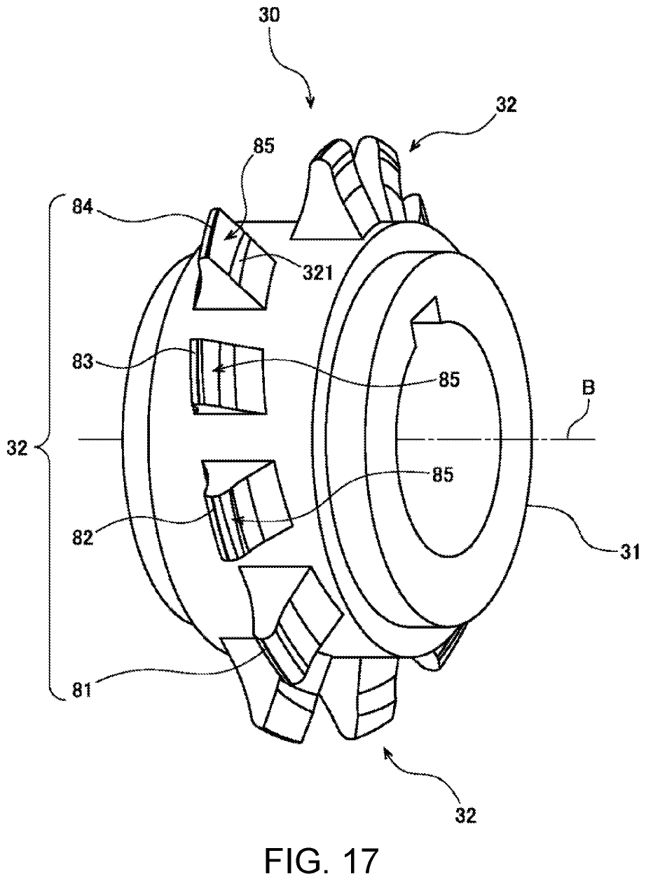

In the above example embodiment, the relieved portion 85 is provided only on the left tooth flank 322 of the right tooth flank 321 and the left tooth flank 322 of the thread 32. That is, in the above example embodiment, the tooth profile of the first region 81 and the tooth profile of the second region 82 are different in the left tooth flank 322 of the thread 32. However, as illustrated in FIG. 17, the relieved portion 85 may be provided only on the right tooth flank 321 out of the right tooth flank 321 and the left tooth flank 322 of the thread 32. That is, in the right tooth flank 321 of the thread 32, the tooth profile of the first region 81 and the tooth profile of the second region 82 may be different.

In this case, it is preferable that a portion of the right tooth flank 321, which is not in contact with the surface of the external tooth 90 on one side in the circumferential direction of the gear axis A, has the relieved portion 85 missing from the tooth profile of the maximum region. In addition, in the right tooth flank 321, the tooth profile of the second region 82 is desirably recessed more than the tooth profile of the first region 81. In this manner, the relieved portion 85 is provided in a portion of the second tooth surface 902 that does not contribute to machining of the tooth tip portion. Therefore, the tooth tip portion of the second tooth surface 902 of the external tooth 90 can be appropriately machined by the right tooth flank 321 of the first region 81.

In the present modification, the relieved portion 85 becomes larger from the first region 81 toward the fourth region 84 along the spiral direction. That is, the tooth profile of the second region 82 is recessed more than the tooth profile of the first region 81, the tooth profile of the third region 83 is recessed more than the tooth profile of the second region 82, and the tooth profile of the fourth region 84 is recessed more than the tooth profile of the third region 83. Then, the first region 81 machines the tooth bottom portion of the first tooth surface 901 of the external tooth 90 of the gear 9. The second region 82 machines the tooth tip side of the tooth bottom portion of the first tooth surface 901. The third region 83 machines the tooth tip side of the portion of the first tooth surface 901 to be machined by the second region 82. The fourth region machines the tooth tip portion of the first tooth surface 901. Accordingly, even when the region from the second region 82 to the fourth region 84 have the relieved portion 85, each portion of the first tooth surface 901 can be appropriately machined.

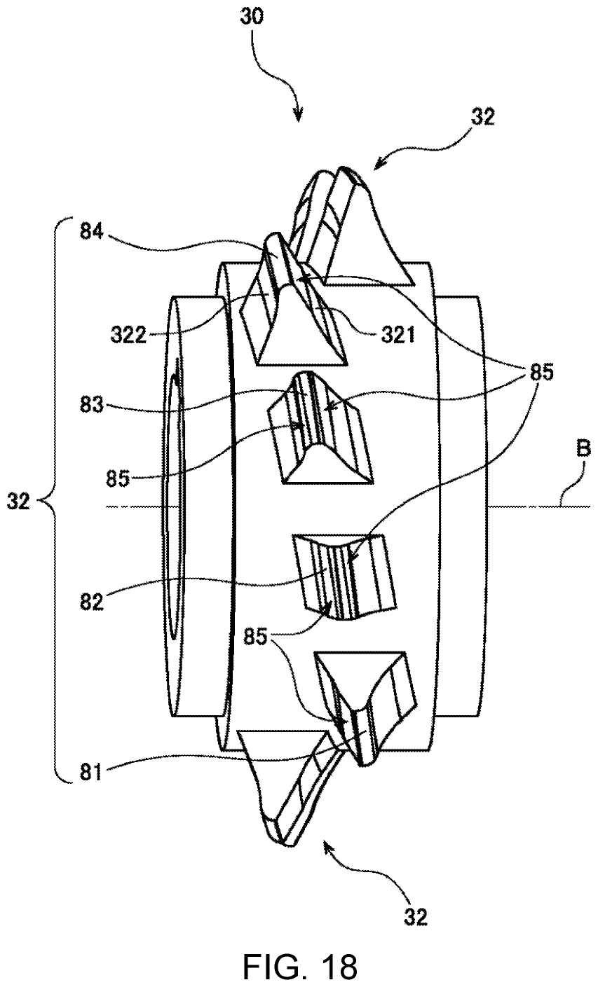

As illustrated in FIG. 18, the relieved portion 85 may be provided on both the right tooth flank 321 and the left tooth flank 322 of the thread 32. That is, the tooth profile of the first region 81 and the tooth profile of the second region 82 may be different in both the right tooth flank 321 and the left tooth flank 322 of the thread 32. As described above, in at least one of the right tooth flank 321 and the left tooth flank 322, the tooth profile of the first region 81 and the tooth profile of the second region 82 are desirably different. As a result, it is possible to appropriately machine the gear 9 while suppressing contact between the tool 30 and the gear 9 on at least one of the right tooth flank 321 and the left tooth flank 322.

For example, in the present example embodiment, the relieved portion 85 of the right tooth flank 321 gradually increases and the relieved portion 85 of the left tooth flank 322 gradually decreases from the first region 81 toward the fourth region 84 along the spiral direction. That is, the tooth profile of the left tooth flank 322 is similar to that in FIGS. 4 to 8, and the tooth profile of the relieved portion 85 of the right tooth flank 321 is similar to that in a first modification of the present example embodiment. Accordingly, the respective portions of the first tooth surface 901 and the second tooth surface 902 of the external tooth 90 can be appropriately machined.

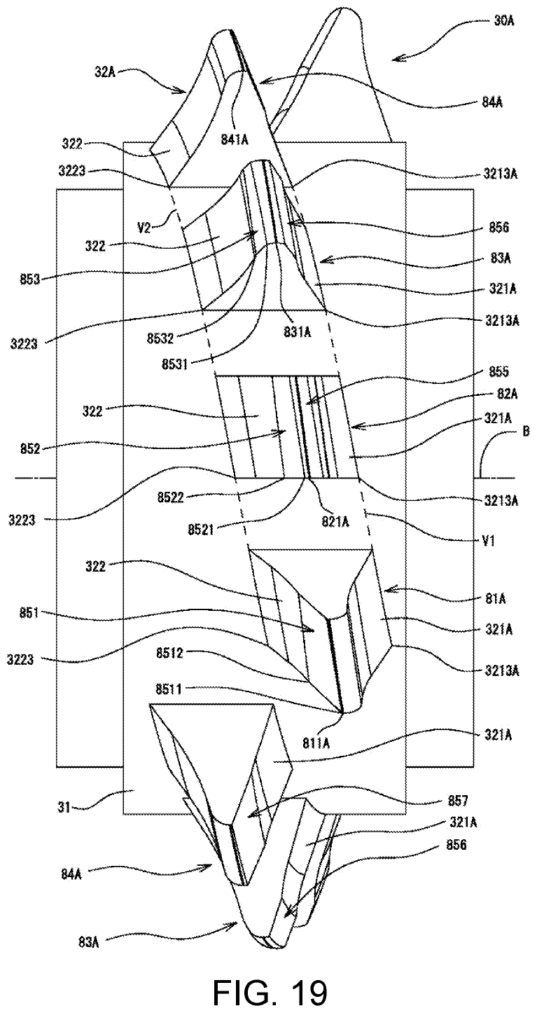

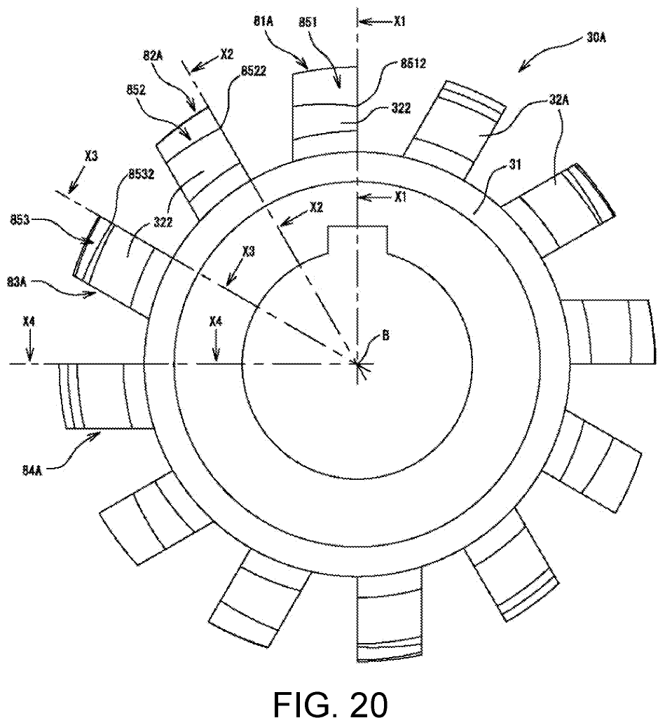

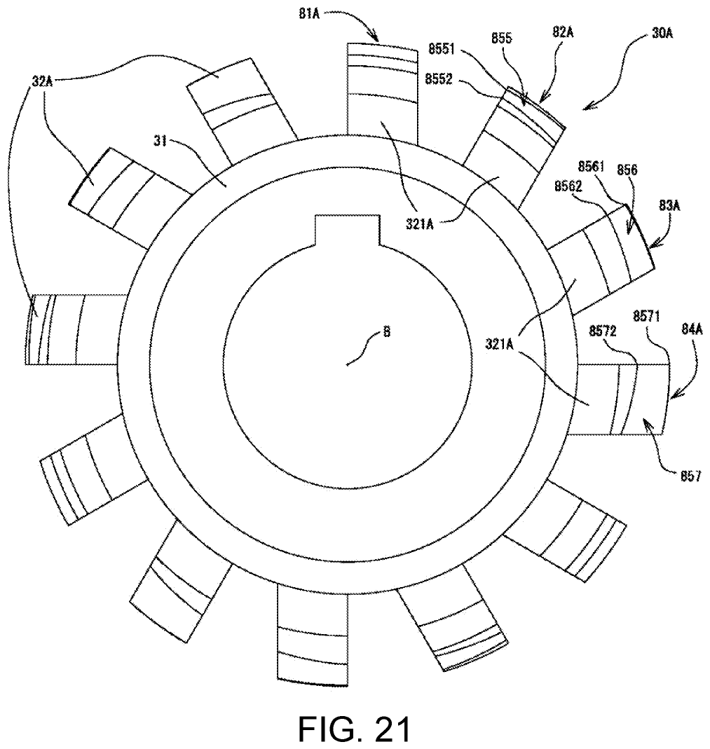

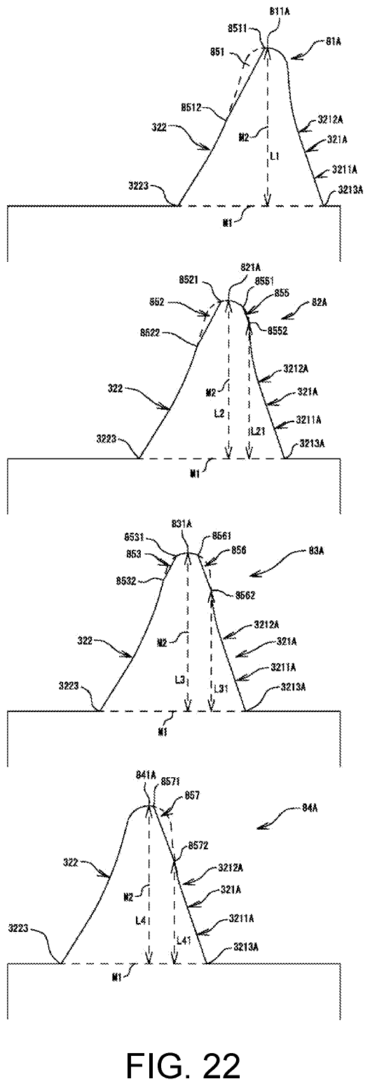

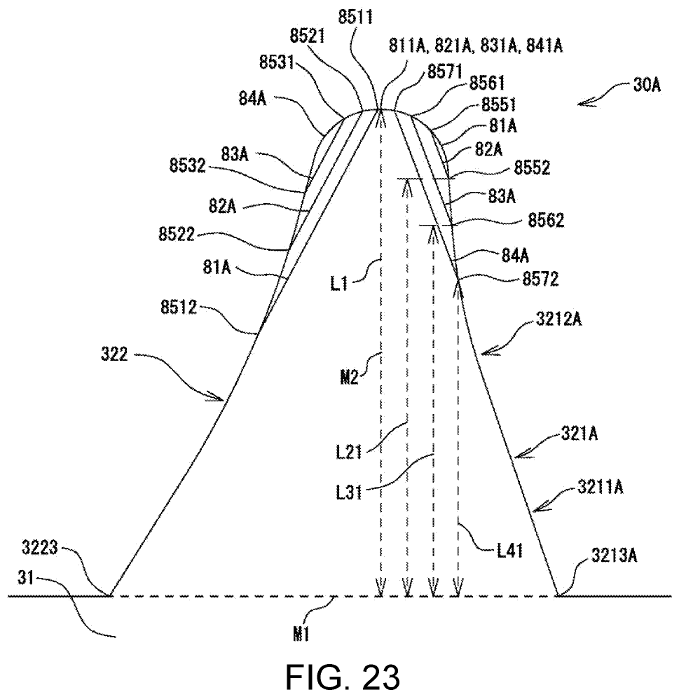

Next, a tool 30A of a second modification will be described with reference to FIGS. 19 to 23. FIG. 19 is a side view of the tool 30A. FIG. 20 is a bottom view of the tool 30A. FIG. 21 is a plan view of the tool 30A. FIG. 22 is a diagram illustrating a tooth profile of a thread 32A. FIG. 23 is a diagram illustrating the tooth profile of the thread 32A in an overlapping manner. Note that, for convenience of description, in FIGS. 19 to 23, the same reference numerals are used for portions having the same shapes as those of the tool 30 of the above-described example embodiment and the tool 30 according to the first modification, and description thereof may be omitted, and different reference numerals are used for portions having shapes and features different from those of the tool 30 of the above-described example embodiment and the tool 30 according to the first modification.

As illustrated in FIGS. 19 to 23, the tool 30A includes a tool body 31 and a thread 32A. The tool body 31 extends along the tool axis B. The thread 32A protrudes in a direction away from the tool axis B on the outer surface of the tool body 31, and is disposed in a spiral shape about the tool axis B.

The thread 32A includes a first region 81A, a second region 82A, a third region 83A, and a fourth region 84A. The first region 81A is a region disposed on one side in the spiral direction. The second region 82A is a region disposed on the other side in the spiral direction with respect to the first region 81A. The third region 83A is disposed on the other side in the spiral direction with respect to the second region 82A, and the fourth region 84A is disposed on the other side in the spiral direction with respect to the third region 83A.

The first region 81A has a one-side tooth flank 321A and an other-side tooth flank 322. The one-side tooth flank 321A is a surface on one side in the tool axis B direction in the first region 81A, and the other-side tooth flank 322 is a surface on the other side in the tool axis B direction in the first region 81A. The second region 82A has a one-side tooth flank 321A and an other-side tooth flank 322. The one-side tooth flank 321A is a surface on one side in the tool axis B direction in the second region 82A, and the other-side tooth flank 322 is a surface on the other side in the tool axis B direction in the second region 82A. Similarly, the third region 83A and the fourth region 84A have a one-side tooth flank 321A which is a surface on one side in the tool axis B direction and an other-side tooth flank 322 which is a surface on the other side in the tool axis B direction. That is, the one-side tooth flank 321A is a surface on one side in the tool axis B direction in the thread 32A, and the other-side tooth flank 322 is a surface on the other side in the tool axis B direction in the thread 32A.

The shape of the other-side tooth flank 322 of the thread 32A is the same as the shape of the other-side tooth flank 322 of the thread 32 in the above example embodiment. Therefore, the relieved portions 851, 852, and 853 on the other side of the other-side tooth flank 322 of the thread 32A are also the same as the relieved portions 851, 852, and 853 on the other side in the above example embodiment, and have the same features as the relieved portion 85 in the above example embodiment. Therefore, the relieved portion 851 on the other side in the first region 81A is defined as a difference in shape between the tooth profile of the first region 81A and the tooth profile of the fourth region 84A in an other-side tooth flank 322A of the first region 81A. The relieved portion 852 on the other side in the second region 82A and the relieved portion 853 on the other side in the third region 83A may also be defined as a difference from the shape of the tooth profile of the first region 81A in the other-side tooth flank 322, similarly to the relieved portion 851A on the other side.

In a second modification of the present example embodiment, the shape of the one-side tooth flank 321A of the thread 32A is different from the shape of the thread 32 in the above example embodiment. In the second modification, the one-side tooth flank 321A in the second region 82A is recessed more than the one-side tooth flank 321A in the first region 81A. Similarly, the one-side tooth flank 321A in the third region 83A is recessed from the one-side tooth flank 321A in the second region 82A, and the one-side tooth flank 321A in the fourth region 84A is recessed from the one-side tooth flank 321A in the third region 83A. Therefore, the one-side tooth flank 321A in the fourth region 84A is recessed more than the one-side tooth flank 321A in the first region 81A. As a result, for example, since the one-side tooth flank 321A of the tooth profile of the fourth region 84A is recessed more than the one-side tooth flank 321A of the tooth profile of the first region 81A, the workpiece can be appropriately machined by the other portion of the one-side tooth flank 321A of the fourth region 84A while suppressing unnecessary contact between the one-side tooth flank 321A of the fourth region 84A and the workpiece. Similarly, also in the second region 82A and the third region 83A, in the portion having the recess, the workpiece can be appropriately machined by other portions while suppressing unnecessary contact with the workpiece.

That is, the second region 82A has a relieved portion 855 on one side, the third region 83A has a relieved portion 856 on one side, and the fourth region 84A has a relieved portion 857 on one side. More specifically, when the difference in the shape of the one-side tooth flank 321A in a case where the tooth profile of the first region 81A and the tooth profile of the fourth region 84A are overlapped is defined as a relieved portion 855 on one side in the second region 82A, the difference in the shape of the one-side tooth flank 321A in a case where the tooth profile of the first region 81A and the tooth profile of the third region 83A are overlapped is defined as a relieved portion 856 on one side in the third region 83A, and the difference in the shape of the one-side tooth flank 321A in a case where the tooth profile of the first region 81A and the tooth profile of the fourth region 84A are overlapped is defined as a relieved portion 857 on one side in the fourth region 84A, the relieved portion 857 in the one-side tooth flank 321A is larger than the relieved portion 856 on one side, and the relieved portion 856 on one side is larger than the relieved portion 855 on one side. That is, on the one-side tooth flank 321A, the tooth profile of the first region 81A is larger than the tooth profile of the second region 82A, the tooth profile of the second region 82A is larger than the tooth profile of the third region 83A, and the tooth profile of the third region 83A is larger than the tooth profile of the fourth region 84A. As a result, for example, since the relieved portion 855 in the one-side tooth flank 321A does not contribute to the processing of the workpiece by the tool 30A, the workpiece can be appropriately machined by the other portion of the one-side tooth flank 321A of the second region 82A while suppressing unnecessary contact between the one-side tooth flank 321A of the second region 82A and the workpiece. Similarly, also in the third region 83A and the fourth region 84A, since the relieved portions 856 and 857 on one side do not contribute to machining of the workpiece by the tool 30A, the workpiece can be appropriately machined by other portions while suppressing unnecessary contact with the workpiece.

As illustrated in FIG. 23, the radially outer end 811A of the first region 81A, the radially outer end 821A of the second region 82A, the radially outer end 831A of the third region 83A, and the radially outer end 841A of the fourth region 84A coincide with each other with respect to the tool axis B. The radially outer end 8551 of the relieved portion 855 on one side in the second region 82A, the radially outer end 8561 of the relieved portion 856 on one side in the third region 83A, and the relieved portion 8571 on one side in the fourth region 84A are disposed on one side in the tool axis B direction with respect to the radially outer end 811A of the first region 81A. As a result, since the radially outer ends 811A, 821A, 831A, and 841A do not have the relieved portions in all the regions of the thread 32A, the workpiece can be machined.

With reference to the tool axis B, the radially outer end 8571 of the relieved portion 857 on one side is disposed radially outward of the radially outer end 8561 of the relieved portion 856 on one side. Similarly, with reference to the tool axis B, the radially outer end 8561 of the relieved portion 856 on one side is disposed radially outward of the radially outer end 8551 of the relieved portion 855 on one side. On the other hand, the tool axis side end 8572 of the relieved portion 857 on one side in the fourth region 84A is disposed closer to the tool axis B side than the tool axis side end 8562 of the relieved portion 856 on one side in the third region 83A, and the tool axis side end 8562 of the relieved portion 856 on one side in the third region 83A is disposed closer to the tool axis B side than the tool axis side end 8552 of the relieved portion 855 on one side in the second region 82A. That is, the radial distance L21 between the line connecting the tool axis B-side end 3213A of the one-side tooth flank 321A and the tool axis B-side end 3223 of the other-side tooth flank 322 and the tool axis side end 8552 of the relieved portion 855 on one side in the second region 82A is longer than the distance L31 in the radial direction between the line connecting the tool axis B-side end 3213A of the one-side tooth flank 321A and the tool axis B-side end 3223 of the other-side tooth flank 322 and the tool axis side end 8562 of the relieved portion 856 on one side in the third region 83A, and the distance L31 in the radial direction is longer than the distance L41 in the radial direction between the line connecting the tool axis B-side end 3213A of the one-side tooth flank 321A and the tool axis B-side end 3223 of the other-side tooth flank 322 and the tool axis side end 8572 of the relieved portion 857 on one side in the fourth region 84A. Thus, by gradually increasing the relieved portions 855, 856, and 857 on one side, it is possible to machine the workpiece by gradually moving the region contributing to machining in each region radially inward from the first region 81A toward the fourth region 84A while avoiding contact between the thread 32A and the workpiece. The distance L1 in the radial direction between the line connecting the tool axis B-side end 3213A of the one-side tooth flank 321A and the tool axis B-side end 3223 of the other-side tooth flank 322 and the radially outer end 811 of the first region 81A is equal to the distance L1 in the above example embodiment.

When the tooth profile of the first region 81A, the tooth profile of the second region 82A, the tooth profile of the third region 83A, and the tooth profile of the fourth region 84A overlap with each other, the entire relieved portion 855 of the second region 82A overlaps with the tooth profile of the first region 81A. That is, the relieved portion 855 does not protrude from the tooth profile of the first region 81A. The entire relieved portion 855 of the second region 82A in the one-side tooth flank 321A overlaps the relieved portion 856 in the third region 83A, and the entire relieved portion 856 on one side in the third region 83A overlaps the relieved portion 857 on one side in the fourth region 84A. That is, the relieved portion 855 on one side includes the entire region without protruding from the relieved portion 856 on one side, and the relieved portion 856 on one side includes the entire region without protruding from the relieved portion 857 on one side. In other words, on the one-side tooth flank 321A, the tooth profile of the first region 81A is larger than the tooth profile of the second region 82A, the tooth profile of the second region 82A is larger than the tooth profile of the third region 83A, and the tooth profile of the third region 83A is larger than the tooth profile of the fourth region 84A. Therefore, when the tooth profile of the first region 81A and the tooth profile of the fourth region 84A are overlapped, the entire relieved portion 857 on one side in the fourth region 84A is included in the tooth profile of the first region 81A. Thus, by gradually increasing the relieved portions 855, 856, and 857 in the one-side tooth flank 321A, it is possible to machine the workpiece by gradually moving the portion contributing to machining in each region radially inward from the first region 81A toward the fourth region 84A while avoiding contact between the thread 32A and the workpiece.

The one-side tooth flank 321A in the first region 81A, the one-side tooth flank 321A in the second region 82A, the one-side tooth flank 321A in the third region 83A, and the one-side tooth flank 321A in the fourth region 84A extend in the direction toward the tool axis B on the other side in the tool axis B direction, that is, the one-side tooth flanks 321A in the first region 81A, the second region 82A, the third region 83A, and the fourth region 84A are recessed in the direction toward the tool axis B on the other side of the tool axis B. Thus, when the workpiece is machined by the tool 30A, it is possible to machine the workpiece by bringing the thread 32A into contact with the workpiece at a portion where machining is necessary while suppressing unnecessary contact between the thread 32A and the workpiece. This is particularly useful when a gear is employed as a workpiece and the gear is cut and chamfered by the tool 30A. In accordance with the shape and the machining method of the workpiece, the one-side tooth flank 321A in at least one of the first region 81A, the second region 82A, the third region 83A, and the fourth region 84A may be recessed in the direction toward the other side of the tool axis B and toward the tool axis B.

Except for the relieved portions 855, 856, and 857 on one side, the shape of the recess in the one-side tooth flank 321A of the thread 32A is the same as the shape of the recess in the one-side tooth flank 321 of the thread 32 in the above example embodiment. That is, with reference to the tool axis B, since the relieved portions 855, 856, and 857 on one side are disposed only radially outward from the midpoint M2, the shape of the one-side tooth flank 321A is the same as the shape of the one-side tooth flank 321A of the thread 32 in the above example embodiment radially inward from the midpoint M2. However, at least a portion of the relieved portions 855, 856, and 857 may be disposed radially inward of the midpoint M2. Thus, the shape of the one-side tooth flank 321A can be appropriately changed in accordance with the shape and the machining method of the workpiece.

The one-side tooth flank 321A of the thread 32A has an inner region 3211A of the one-side tooth flank 321A disposed radially inward with respect to the tool axis B, and an outer region 3212A disposed radially outward with respect to the tool axis B. The shapes of the inner region 3211A and the outer region 3212A of the one-side tooth flank 321A match the shapes of the inner region 3211 and the outer region 3212 of the thread 32 in the above example embodiment. In other words, the shape of the portion disposed radially inward of the one-side tooth flank 321A is the same as the shape of the one-side tooth flank 321 in the above example embodiment except for the shapes of the relieved portions 855, 856, and 857 on one side. Thus, in the thread 32A, by providing the relieved portions 855, 856, and 857 on one side in the region from the second region 82A to the fourth region 84A, the workpiece can be appropriately machined by the inner region 3211A and the outer region 3212A while suppressing unnecessary contact between the one-side tooth flank 321A and the workpiece. In particular, the shape is useful for cutting and chamfering a gear as an example of machining a workpiece.

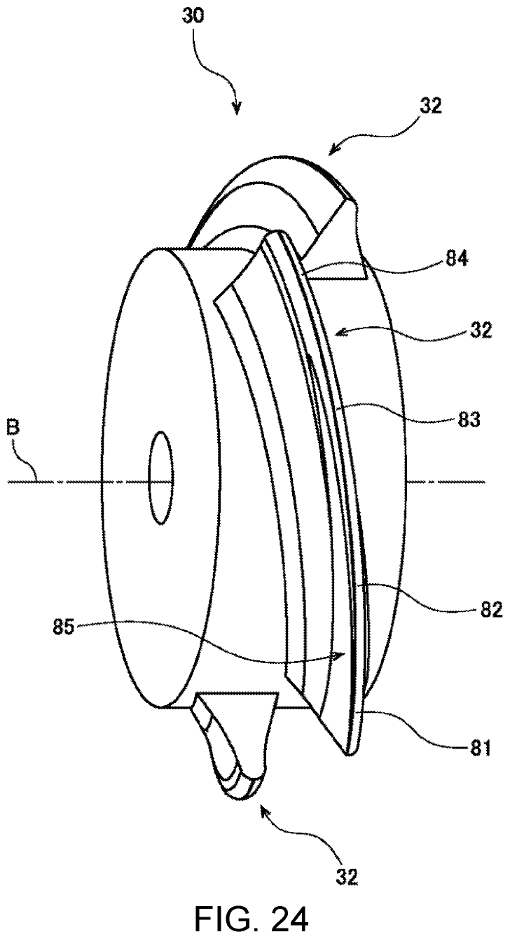

The tool 30 of the above example embodiment is a hob cutter for chamfering the external teeth 90 of the gear 9. However, the tool of the present disclosure may be a tool other than the hob cutter. FIG. 24 is a perspective view of a tool 30 according to a third modification of the present example embodiment. The tool 30 in FIG. 24 is a grindstone for grinding the surface of the external tooth 90 of the gear 9.

In the example of FIG. 24, no groove is formed between the first region 81 and the second region 82, between the second region 82 and the third region 83, and between the third region 83 and the fourth region 84. Therefore, in the example of FIG. 24, the first region 81, the second region 82, the third region 83, and the fourth region 84 continuously extend along the spiral of the thread 32.

Also in the example of FIG. 24, the tooth profiles of the first region 81, the second region 82, the third region 83, and the fourth region 84 are the same as those of the above example embodiment or modification. That is, the relieved portion 85 can be provided on at least one of the right tooth flank 321 and the left tooth flank 322 of the thread 32. As a result, the tooth profile of the first region 81 and the tooth profile of the second region 82 can be made different from each other. As a result, it is possible to suppress the thread 32 from coming into contact with the adjacent external tooth 90 when the external tooth 90 of the gear 9 is machined.

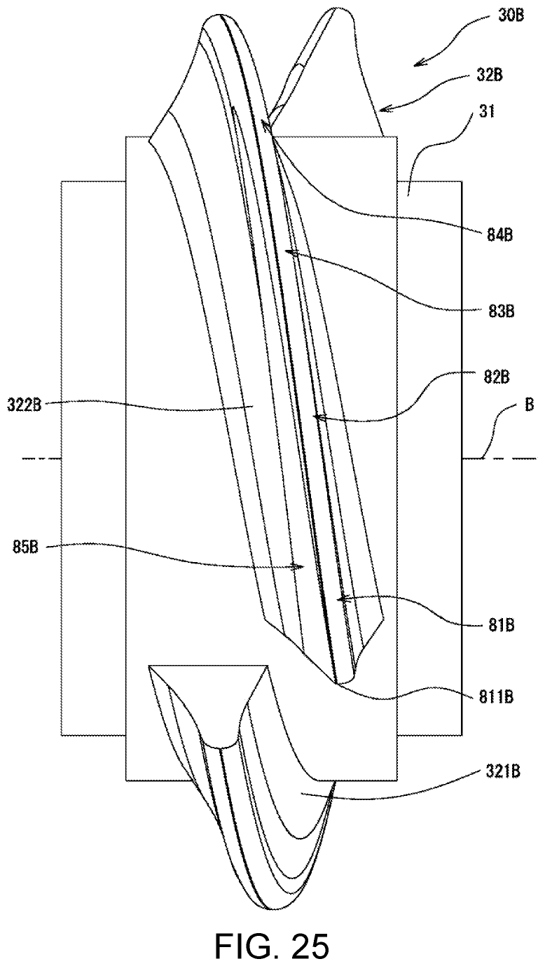

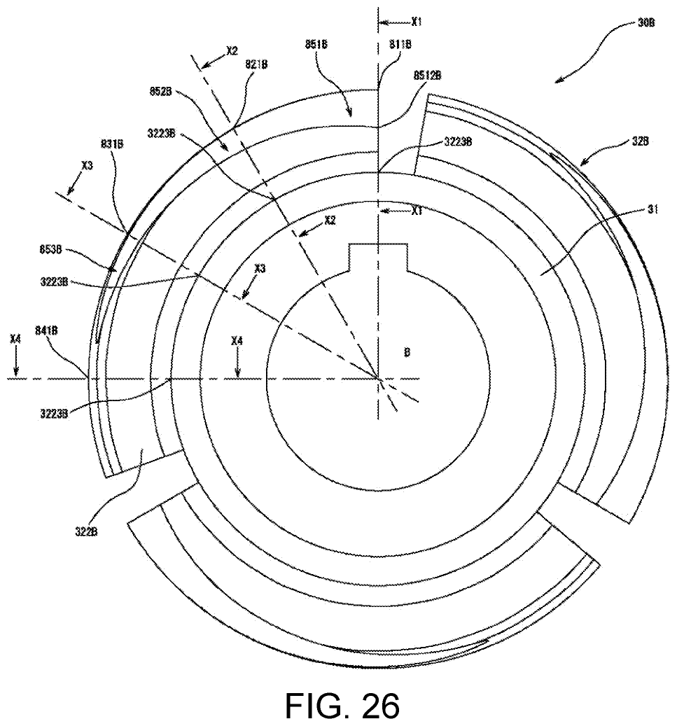

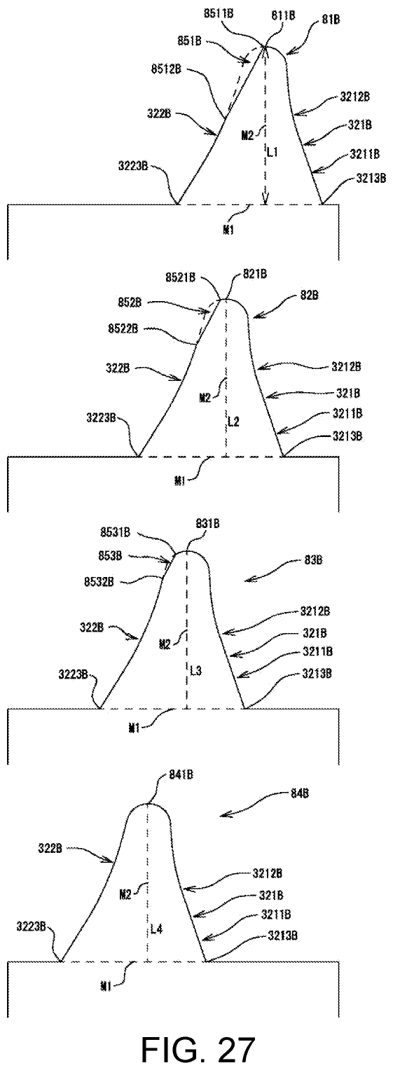

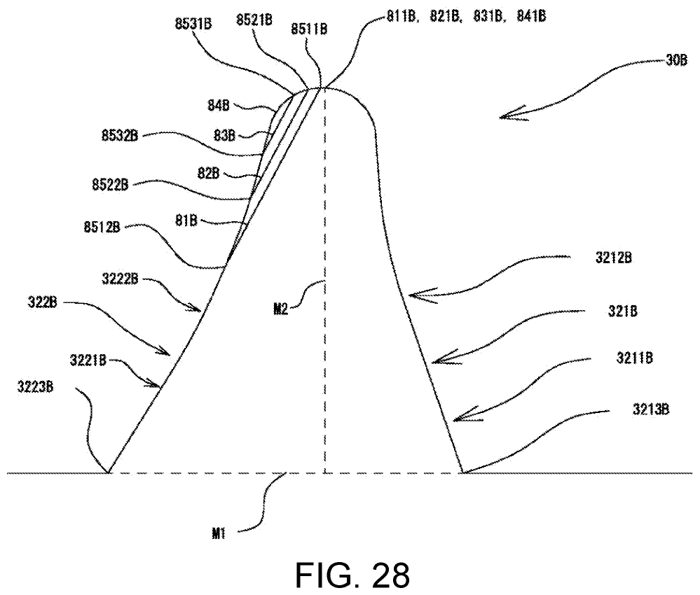

Next, a tool 30B of the third modification will be described with reference to FIGS. 25 to 28. FIG. 25 is a side view of the tool 30B. FIG. 26 is a bottom view of the tool 30B. FIG. 27 is a diagram illustrating the tooth profile of a thread 32B. FIG. 28 is a diagram illustrating the tooth profile of the thread 32B in an overlapping manner. Note that, for convenience of description, in FIGS. 25 to 28, the same reference numerals are used for portions having the same shape as the tool 30 of the above-described example embodiment, and description thereof may be omitted, and different reference numerals are used for portions having shapes and features of the tool 30 different from those of the tool 30 of the above-described example embodiment.

As described in FIG. 25, the tool 30B is a grindstone. Therefore, the tool 30B is mainly used when finishing a gear roughly machined by a hob or the like. The tool 30B has a spirally arranged thread 32B extending around the tool axis B. The thread 32B is a portion that protrudes radially outward with respect to the tool axis B from the cylindrical tool body 31 disposed along the tool axis B.

As described in FIG. 26, similarly to the example embodiment and the second modification, X1-X1, X2-X2, X3-X3, and X4-X4 are virtual planes extending in the radial direction passing through the tool axis B, and when viewed along the tool axis B, an angle formed by X1-X1 and X2-X2 is approximately 30 degrees, an angle formed by X2-X2 and X3-X3 is approximately 30 degrees, and an angle formed by X3-X3 and X4-X4 is approximately 30 degrees.

The thread 32B includes a first region 81B, a second region 82B, a third region 83B, and a fourth region 84B. The first region 81B is a region where the thread 32B intersects the X1-X1 cross section, the second region 82B is a region where the thread 32B intersects the X2-X2 cross section, the third region 83B is a region where the thread 32B intersects the X3-X3 cross section, and the fourth region 84B is a region where the thread 32B intersects the X4-X4 cross section. In the drawing, the tooth profile of the first region 81B in the X1-X1 cross section, the tooth profile of the second region 82B in the X2-X2 cross section, the tooth profile of the third region 83B in the X3-X3 cross section, and the tooth profile of the fourth region 84B in the X4-X4 cross section are arranged.

Referring to FIGS. 27 and 28, the tooth profile in each of the first region 81B, the second region 82B, the third region 83B, and the fourth region 84B matches the tooth profile in each of the first region 81, the second region 82, the third region 83, and the fourth region 84 of the above example embodiment. That is, the thread 32B has a shape extending spirally, and the first region 81B, the second region 82B, the third region 83B, and the fourth region 84B are connected in the spiral direction, but the tooth profile of each region coincides with the tooth profile of each region in the thread 32 in the above example embodiment. As another modification in the case where the tool is a grindstone, the tooth profile in each of the first region, the second region, the third region, and the fourth region may have a shape that matches the tooth profile in each of the first region 81A, the second region 82A, the third region 83A, and the fourth region 84A of the second modification.

The thread 32B has a one-side tooth flank 321B which is a surface on one side in the tool axis B direction and an other-side tooth flank 322B which is a surface on the other side in the tool axis B direction. The other-side tooth flank 322B has a relieved portion 85B. Referring to the drawings, the shapes of a relieved portion 851B on the other side in the first region 81B, the relieved portion 852B on the other side in the second region 82B, and the relieved portion 853B on the other side in the third region 83B match the shapes of the relieved portion 851 on the other side, the relieved portion 852 on the other side, and the relieved portion 853 on the other side in the example embodiment. Therefore, also in the thread 32B, since the relieved portion 851B, 852B, and 853B on the other side in each region do not contribute to machining of the workpiece, the workpiece can be appropriately machined by other portions while suppressing unnecessary contact between the thread 32B and the workpiece. This feature is useful when chamfering a gear, particularly when the gear is adopted as a workpiece.

With reference to the tool axis B, a radially outer end 8511B of a relieved portion 851B on the other side is disposed radially outward of a radially outer end 8521B of a relieved portion 852B on the other side, and the radially outer end 8521B of the relieved portion 852B on the other side is disposed radially outward of a radially outer end 8531B of a relieved portion 853B on the other side. Similarly, with reference to the tool axis B, a radially inner end 8512B of the relieved portion 851B on the other side is disposed radially inward of a radially inner end 8522B of the relieved portion 852B on the other side, and the radially inner end 8522B of the relieved portion 852B on the other side is disposed radially inward of a radially inner end 8532B of the relieved portion 853B on the other side. That is, the relieved portion 85B becomes smaller from the first region 81B toward the third region 83B. In other words, the tooth profile of the first region 81B is recessed more than the tooth profile of the second region 82B, the tooth profile of the second region 82B is recessed more than the tooth profile of the third region 83B, and the tooth profile of the third region 83B is recessed more than the tooth profile of the fourth region 84B. As a result, when machining a workpiece with the tool 30B, the workpiece can be appropriately machined at a portion other than the relieved portion 85B while suppressing unnecessary contact between each region of the thread 32B and the workpiece. Also in the third modification, the shape of the relieved portion 85B is defined as a difference between the tooth profile of each region and the tooth profile of a fourth region B which is the maximum region and the reference region.

The shapes of the one-side tooth flank 321B and the other-side tooth flank 322B in each region respectively coincide with the shapes of the one-side tooth flank 321 and the other-side tooth flank 322 in the above example embodiment. Therefore, the one-side tooth flank 321B is recessed in a direction toward the other side of the tool axis B and toward the tool axis B. In each region, the shape of an inner region 3211B of the one-side tooth flank 321B matches the shape of the inner region 3211 in the above example embodiment, and the shape of an outer region 3212B of the one-side tooth flank 321B matches the shape of the outer region 3212 in the above example embodiment. Therefore, in each region, a tool axis B-side end 3213B of the one-side tooth flank 321B coincides with the tool axis B-side end 3213 in the above example embodiment.

Similarly, the other-side tooth flank 322B is recessed in a direction toward the tool axis B on one side of the tool axis B. In each region, the shape of an inner region 3221B of the other-side tooth flank 322B matches the shape of the inner region 3221 in the above example embodiment, and the shape of an outer region 3222B of the other-side tooth flank 322B matches the shape of the outer region 3222 in the above example embodiment. In each region, a tool axis B-side end 3223B of the other-side tooth flank 322B coincides with the tool axis B-side end 3223 in the above example embodiment.

The radially outer ends 8511B, 8521B, and 8531B are all disposed on one side in the tool axis B direction with respect to the midpoint M1 in the tool axis B direction between the radially inner end 3213B of the one-side tooth flank 321B of the first region 81B and a radially inner end 3223B of the other-side tooth flank 322B of the first region 81B. Similarly, the radially inner ends 8512B, 8522B, and 8532B are all disposed on the other side in the tool axis B direction with respect to the midpoint M1 in the tool axis B direction between the radially inner end 3213B of the one-side tooth flank 321B of the first region 81B and the radially inner end 3223B of the other-side tooth flank 322B of the first region 81B.

With reference to FIGS. 26, 27, and 28, the radial position of the radially outer end 811B in the first region 81B, the radial position of the radially outer end 821B in the second region 82B, the radial position of the radially outer end 831B in the third region 83B, and the radial position of the radially outer end 841B in the fourth region 84B all coincide with each other with respect to the tool axis B. That is, with reference to the tool axis B, the distances L1, L2, L3, and L4 between the radially outer ends 8511B, 8521B, 8531B, and 8541B and the line connecting the radially inner end 3213B and the radially inner end 3223B in each region are all equal. Further, the radially inner ends 8512B, 8522B, 8532B, and 8542B of the respective regions are all disposed radially outward from the midpoint M2 in the radial direction between a line connecting the radially inner end 3213B of the one-side tooth flank 321B of the respective regions and the radially inner end 3223B of the one-side tooth flank 322B of the respective regions and the radially outer ends 811B, 821B, 831B, and 841B of the respective regions.

Since the tool 30B is a grindstone, the radially inner end of the thread 32B, that is, the root portion of the thread 32B is connected in the spiral direction. That is, the root portion of the thread 32B is disposed along the virtual lines V1 and V2 in the above example embodiment. As a result, for example, in a region in the spiral direction of the thread 32B, the workpiece can be appropriately machined by the root portion of the thread 32B. This feature is particularly useful, for example, when machining a gear with the tool 30B, and when machining a tooth surface on one side of the gear with the one-side tooth flank 321B and machining a tooth surface on the other side of the gear with the other-side tooth flank 322B.

The machining device 1 may have at least one of a machining configuration in which the right tooth flank 321 of the first region 81 machines the tooth bottom portion of the external tooth 90 on one side in the circumferential direction of the gear axis A, and the right tooth flank 321 of the second region 82 machines the tooth tip side of the tooth bottom portion of the surface of the external tooth 90 on one side in the circumferential direction of the gear axis A, and a machining configuration in which the left tooth flank 322 of the first region 81 machines the tooth tip portion of the external tooth 90 on the other side in the circumferential direction of the gear axis A, and the left tooth flank 322 of the second region 82 machines the tooth bottom side of the tooth tip portion of the surface of the external tooth 90 on the other side in the circumferential direction of the gear axis A. Further, the thread 21 may have at least one of a tool configuration in which the tooth profile of the first region 81 is recessed more than the tooth profile of the second region 82 on the left tooth flank 322 and a tool configuration in which the tooth profile of the second region 82 is recessed more than the tooth profile of the first region 81 on the right tooth flank 321. As a result, it is possible to suppress interference between the tool 30 and at least one tooth surface of the external tooth 90.

In addition, the machining device 1 may have both a machining configuration in which the right tooth flank 321 of the first region 81 machines the tooth tip side of the tooth bottom portion of the external tooth 90 on one side in the circumferential direction of the gear axis A, and the right tooth flank 321 of the second region 82 machines the tooth top side of the surface of the external tooth 90 on one side in the circumferential direction of the gear axis A, and a machining configuration in which the left tooth flank 322 of the first region 81 machines the tooth tip portion of the external tooth 90 on the other side in the circumferential direction of the gear axis A, and the left tooth flank 322 of the second region 82 machines the tooth bottom side of the tooth tip portion of the surface of the external tooth 90 on the other side in the circumferential direction of the gear axis A. As a result, interference between the tool 30 and both tooth surfaces of the external teeth 90 can be suppressed.

Further, the thread 21 may have both a tool configuration in which the tooth profile of the first region 81 is recessed more than the tooth profile of the second region 82 on the left tooth flank 322 and a tool configuration in which the tooth profile of the second region 82 is recessed more than the tooth profile of the first region 81 on the right tooth flank 321. As a result, interference between the tool 30 and both tooth surfaces of the external teeth 90 can be suppressed.

In the above example embodiment, the gear 9 to be machined is a helical gear. However, the gear to be machined in the present disclosure may be another type of gear such as a spur gear.

In the tool 30 of the above example embodiment, both the first tooth surface 901 and the second tooth surface 902 of the external tooth 90 are machined. However, the tool of the present disclosure may machine only one of the first tooth surface and the second tooth surface of the external tooth.

Also note that features of the above-described example embodiments and modifications thereof may be combined appropriately as long as no conflict arises.

The present technology can have the following configurations.

(1) A tool including: a tool body extending along a tool axis; and
a thread protruding in a direction away from the tool axis on an outer surface of the tool body and disposed in a spiral shape about the tool axis, in which the thread includes: a first region disposed on one side in the spiral direction; and a reference region disposed on another side in the spiral direction with respect to the first region, the first region includes: a one-side tooth flank that is a surface on one side in a tool axial direction; and an other-side tooth flank which is a surface on another side in the tool axial direction, the reference region includes: a one-side tooth flank that is a surface on one side in the tool axial direction; and an other-side tooth flank that is a surface on another side in the tool axial direction, in at least one of the one-side tooth flank and the other-side tooth flank in a tooth profile of the reference region, an angle between an inner region disposed on a tool axis side and the outer surface of the tool body is smaller than an angle between an outer region disposed in a direction farther from the tool axis than the inner region and an outer surface of the tool body, and the other-side tooth flank in the first region is recessed more than the other-side tooth flank in the reference region.

(2) The tool according to (1), in which the thread includes a second region disposed between the first region and the reference region in the spiral direction, the second region includes: a one-side tooth flank that is a surface on one side in the tool axial direction; an other-side tooth flank that is a surface on another side in the tool axial direction, and the other-side tooth flank in the second region is recessed more than the other-side tooth flank in the reference region, and the other-side tooth flank in the first region is recessed more than the other-side tooth flank in the second region.

(3) The tool according to (2), in which, in a case where a difference in shape of the other-side tooth flank when a tooth profile of the first region and a tooth profile of the reference region are overlapped is defined as a relieved portion on another side, and a difference in shape of the other-side tooth flank when a tooth profile of the second region and the tooth profile of the reference region are overlapped is defined as an relieved portion on another side, an end on the tool axis side of the relieved portion on the other side in the first region is disposed closer to the tool axis side than an end on the tool axis side of the relieved portion on the other side in the second region.

(4) The tool according to any one of (1) to (3), in which, in a case where a difference in shape of the other-side tooth flank when a tooth profile of the first region and a tooth profile of the reference region are overlapped is defined as a relieved portion on another side, the entire relieved portion on the other side of the first region is included in the tooth profile of the reference region when the tooth profile of the first region and the tooth profile of the reference region are overlapped.

(5) The tool according to any one of (1) to (4), in which, when the tooth profile of the first region and the tooth profile of the reference region are overlapped, the end on the tool axis side of the one-side tooth flank, the end on the tool axis side of the other-side tooth flank, and a radially outer end with reference to the tool axis in a tooth profile of the first region respectively coincide with the end on the tool axis side of the one-side tooth flank, the end on the tool axis side of the other-side tooth flank, and a radially outer end with reference to the tool axis in the tooth profile of the reference region.

(6) The tool according to any one of (1) to (5), in which a shape of the one-side tooth flank in a tooth profile of the first region coincides with a shape of the one-side tooth flank in a tooth profile of the reference region.

(7) The tool according to any one of (1) to (5), in which the one-side tooth flank in the reference region is recessed more than the one-side tooth flank in the first region.

(8) The tool according to any one of (1) to (5), in which, in a case where a difference in shape on the one-side tooth flank when a tooth profile of the first region and the tooth profile of the reference region are overlapped is defined as a relieved portion on one side in the reference region, an entire relieved portion on the one side in the reference region is included in the tooth profile of the first region when the tooth profile of the first region and the tooth profile of the reference region are overlapped.

(9) A machining device for machining a gear, the machining device including: the tool according to any one of (1) to (8); a tool driver that rotates the tool about the tool axis; and a gear driver that rotates the gear about a gear axis disposed non-parallel to the tool axis.

(10) A machining device for machining a gear, the machining device including: a tool; a tool driver that rotates the tool about a tool axis; and a gear driver that rotates the gear about a gear axis disposed non-parallel to the tool axis. The tool includes: a tool body extending along the tool axis; and a thread protruding in a direction away from the tool axis on an outer surface of the tool body and arranged in a spiral shape about the tool axis. The thread includes a first region and a second region disposed at different positions along the spiral. The thread includes: a right tooth flank that is a surface on one side in a tool axial direction; and a left tooth flank that is a surface on another side in the tool axial direction. The gear has a plurality of teeth. The machining device has at least one machining configuration including: a machining configuration in which the right tooth flank of the first region machines a tooth bottom portion of a surface of the tooth on one side in a circumferential direction of the gear axis, and the right tooth flank of the second region machines a tooth tip side of a tooth bottom portion of a surface of the tooth on one side in a circumferential direction of the gear axis; and a machining configuration in which the left tooth flank of the first region machines a tooth tip portion of a surface of the tooth on another side in a circumferential direction of the gear axis, and the left tooth flank of the second region machines a tooth bottom side of a surface of the tooth on the other side in a circumferential direction of the gear axis with respect to the tooth tip portion. The thread has at least one of a tool configuration including: a tool configuration in which a tooth profile of the first region is recessed more than a tooth profile of the second region on the left tooth flank; and a tool configuration in which the tooth profile of the second region is recessed more than the tooth profile of the first region on the right tooth flank.

(11) The machining device according to (10), in which the machining device has both machining configurations including: a machining configuration in which the right tooth flank of the first region machines a tooth bottom portion of a surface of the tooth on one side in a circumferential direction of the gear axis, and the right tooth flank of the second region machines a tooth tip side of a tooth bottom portion of a surface of the tooth on one side in a circumferential direction of the gear axis; and a machining configuration in which the left tooth flank of the first region machines a tooth tip portion of a surface of the tooth on another side in a circumferential direction of the gear axis, and the left tooth flank of the second region machines a tooth bottom side of a surface of the tooth on the other side in a circumferential direction of the gear axis with respect to the tooth tip portion.

(12) The machining device according to (10), in which the thread has both tool configurations including: a tool configuration in which the tooth profile of the first region is recessed more than the tooth profile of the second region on the left tooth flank; and a tool configuration in which the tooth profile of the second region is recessed more than the tooth profile of the first region on the right tooth flank.

(13) The machining device according to (11), in which the thread has both tool configurations including: a tool configuration in which the tooth profile of the first region is recessed more than the tooth profile of the second region on the left tooth flank; and a tool configuration in which the tooth profile of the second region is recessed more than the tooth profile of the first region on the right tooth flank.

(14) The machining device according to any one of (10) to (13), in which the thread includes a maximum region that is disposed at a position opposite to the first region along the spiral with reference to the second region and has a most convex tooth profile, and the tooth profile of the second region is recessed more than the tooth profile of the maximum region.

(15) The machining device according to (14), in which, in a portion of the left tooth flank that is not in contact with a surface of the tooth on another side in a circumferential direction of the gear axis, a relieved portion missing from the tooth profile of the maximum region is provided.

(16) The machining device according to (14), in which, in a portion of the right tooth flank that is not in contact with a surface of the tooth on one side in a circumferential direction of the gear axis, a relieved portion missing from a tooth profile of the maximum region is provided.

(17) The machining device according to any one of (10) to (16), in which the gear is a helical gear.

(18) The machining device according to any one of (10) to (17), in which the thread machines a tooth bottom of the gear in such a way that, after machining a surface of the tooth on one side in a circumferential direction, the tool driver or the gear driver shifts a phase of rotation of the tool with respect to rotation of the gear, or shifts a relative position between the tool and the gear in a direction intersecting the gear axis.

The present disclosure can be used for, for example, a tool and a machining device.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A tool comprising:
a tool body extending along a tool axis; and
a thread protruding in a direction away from the tool axis on an outer surface of the tool body and provided in a spiral shape about the tool axis; wherein
the thread includes:
a first region located on one side in a spiral direction; and
a reference region located on another side in the spiral direction with respect to the first region;
the first region includes:
a one-side tooth flank that is a surface on one side in a tool axial direction; and
another-side tooth flank that is a surface on another side in the tool axial direction;
the reference region includes:
a one-side tooth flank that is a surface on one side in the tool axial direction; and
another-side tooth flank that is a surface on another side in the tool axial direction;
in at least one of the one-side tooth flank and the another-side tooth flank in a tooth profile of the reference region, an angle between an inner region located on a tool axis side and the outer surface of the tool body is smaller than an angle between an outer region located in a direction farther from the tool axis than the inner region and an outer surface of the tool body; and
the other-side tooth flank in the first region is recessed more than the another-side tooth flank in the reference region.

2. The tool according to claim 1, wherein
the thread includes a second region located between the first region and the reference region in the spiral direction, the second region includes:
a one-side tooth flank that is a surface on one side in the tool axial direction;
another-side tooth flank that is a surface on another side in the tool axial direction; and
the another-side tooth flank in the second region is recessed more than the another-side tooth flank in the reference region; and
the another-side tooth flank in the first region is recessed more than the another-side tooth flank in the second region.

3. The tool according to claim 2, wherein, in a case where a difference in shape of the another-side tooth flank when a tooth profile of the first region and a tooth profile of the reference region are overlapped is defined as a relieved portion on another side and a difference in shape of the another-side tooth flank when a tooth profile of the second region and the tooth profile of the reference region are overlapped is defined as an relieved portion on another side:
an end on the tool axis side of the relieved portion on the other side in the first region is located closer to the tool axis side than an end on the tool axis side of the relieved portion on the other side in the second region.

4. The tool according to claim 1, wherein
where a difference in shape of the another-side tooth flank when a tooth profile of the first region and a tooth profile of the reference region are overlapped is defined as a relieved portion on another side:
an entirety of the relieved portion on the another side of the first region is included in the tooth profile of the reference region when the tooth profile of the first region and the tooth profile of the reference region are overlapped.

5. The tool according to claim 4, wherein
when the tooth profile of the first region and the tooth profile of the reference region are overlapped, an end on the tool axis side of the one-side tooth flank, an end on the tool axis side of the another-side tooth flank, and a radially outer end with reference to the tool axis in the tooth profile of the first region respectively coincide with the end on the tool axis side of the one-side tooth flank, the end on the tool axis side of the another-side tooth flank, and a radially outer end with reference to the tool axis in the tooth profile of the reference region.

6. The tool according to claim 1, wherein
a shape of the one-side tooth flank in a tooth profile of the first region coincides with a shape of the one-side tooth flank in the tooth profile of the reference region.

7. The tool according to claim 1, wherein
the one-side tooth flank in the reference region is recessed more than the one-side tooth flank in the first region.

8. The tool according to claim 7, wherein
where a difference in shape on the one-side tooth flank when a tooth profile of the first region and the tooth profile of the reference region are overlapped is defined as a relieved portion on one side in the reference region:
an entirety of the relieved portion on the one side in the reference region is included in the tooth profile of the first region when the tooth profile of the first region and the tooth profile of the reference region are overlapped.

9. A machining device for machining a gear, the machining device comprising:
the tool according to claim 1;
a tool driver that rotates the tool about the tool axis; and
a gear driver that rotates the gear about a gear axis disposed non-parallel to the tool axis.

10. A machining device for machining a gear, the machining device comprising:
a tool;
a tool driver that rotates the tool about a tool axis; and
a gear driver that rotates the gear about a gear axis disposed non-parallel to the tool axis; wherein
the tool includes:
a tool body extending along the tool axis; and
a thread protruding in a direction away from the tool axis on an outer surface of the tool body and provided in a spiral shape about the tool axis;
the thread includes a first region and a second region located at different positions along the spiral shape;
the thread includes:
a right tooth flank that is a surface on one side in a tool axial direction; and
a left tooth flank that is a surface on another side in the tool axial direction;
the gear includes a plurality of teeth;
the machining device includes at least one machining configuration including:
a machining configuration in which the right tooth flank of the first region machines a tooth bottom portion of a surface of the tooth on one side in a circumferential direction of the gear axis, and the right tooth flank of the second region machines a tooth tip side of the surface of the tooth on one side in the circumferential direction of the gear axis with respect to the tooth bottom portion; and
a machining configuration in which the left tooth flank of the first region machines a tooth tip portion of a surface of the tooth on another side in the circumferential direction of the gear axis, and the left tooth flank of the second region machines a tooth bottom side of a surface of the tooth on the other side in the circumferential direction of the gear axis with respect to the tooth tip portion; and
the thread includes at least one of a tool configuration including:
a tool configuration in which a tooth profile of the first region is recessed more than a tooth profile of the second region on the left tooth flank; and
a tool configuration in which a tooth profile of the second region is recessed more than a tooth profile of the first region on the right tooth flank.

11. The machining device according to claim 10, wherein
the machining device includes both machining configurations including:
a machining configuration in which the right tooth flank of the first region machines the tooth bottom portion of the surface of the tooth on one side in the circumferential direction of the gear axis, and the right tooth flank of the second region machines a tooth tip side of a surface of the tooth on the one side in the circumferential direction of the gear axis with respect to the tooth bottom portion; and
a machining configuration in which the left tooth flank of the first region machines a tooth tip portion of a surface of the tooth on another side in the circumferential direction of the gear axis, and the left tooth flank of the second region machines a tooth bottom side of a surface of the tooth on the other side in the circumferential direction of the gear axis with respect to the tooth tip portion.

12. The machining device according to claim 10, wherein
the thread includes both tool configurations including:
a tool configuration in which the tooth profile of the first region is recessed more than the tooth profile of the second region on the left tooth flank; and
a tool configuration in which the tooth profile of the second region is recessed more than the tooth profile of the first region on the right tooth flank.

13. The machining device according to claim 11, wherein
the thread includes both tool configurations including:
a tool configuration in which the tooth profile of the first region is recessed more than the tooth profile of the second region on the left tooth flank; and
a tool configuration in which the tooth profile of the second region is recessed more than the tooth profile of the first region on the right tooth flank.

14. The machining device according to claim 10, wherein
the thread includes a maximum region that is located at a position opposite to the first region along the spiral shape with reference to the second region and has a most convex tooth profile; and
the tooth profile of the second region is recessed more than a tooth profile of the maximum region.

15. The machining device according to claim 14, wherein
in a portion of the left tooth flank that is not in contact with a surface of the tooth on the other side in a circumferential direction of the gear axis, a relieved portion missing from the tooth profile of the maximum region is provided.

16. The machining device according to claim 14, wherein
in a portion of the right tooth flank that is not in contact with a surface of the tooth on one side in a circumferential direction of the gear axis, a relieved portion missing from the tooth profile of the maximum region is provided.

17. The machining device according to claim 10, wherein
the gear is a helical gear.

18. The machining device according to claim 10, wherein
the thread machines a tooth bottom of the gear in such a way that, after machining a surface of the tooth on one side in a circumferential direction, the tool driver or the gear driver shifts a phase of rotation of the tool with respect to rotation of the gear, or shifts a relative position between the tool and the gear in a direction intersecting the gear axis.

19. A method of machining a gear with a machining device including:
a tool;
a tool driver that rotates the tool about a tool axis; and
a gear driver that rotates the gear about a gear axis disposed non-parallel to the tool axis; wherein
the tool includes:
a tool body extending along the tool axis; and
a thread protruding in a direction away from the tool axis on an outer surface of the tool body and provided in a spiral shape about the tool axis;
the thread includes a first region and a second region located at different positions along the spiral shape;
the thread includes:
a right tooth flank that is a surface on one side in a tool axial direction; and
a left tooth flank that is a surface on another side in the tool axial direction;
the gear includes a plurality of teeth;
the machining method comprising:
performing at least one of:
machining a tooth bottom portion of a surface of the tooth on one side in a circumferential direction of the gear axis configuration with the right tooth flank of the first region, and machining a tooth tip side of the surface of the tooth on one side in the circumferential direction of the gear axis with respect to the tooth bottom portion with the right tooth flank of the second region; and
machining a tooth tip portion of a surface of the tooth on another side in the circumferential direction of the gear axis with the left tooth flank of the first region machines, and machining a tooth bottom side of a surface of the tooth on the other side in the circumferential direction of the gear axis with respect to the tooth tip portion with the left tooth flank of the second region;
performing machining the tooth bottom portion of the surface of the tooth on one side in the circumferential direction of the gear axis with the right tooth flank of the first region, and machining a tooth tip side of a surface of the tooth on the one side in the circumferential direction of the gear axis with respect to the tooth bottom portion with the right tooth flank of the second region; and
performing machining a tooth tip portion of a surface of the tooth on another side in the circumferential direction of the gear axis with the left tooth flank of the first region, and machining a tooth bottom side of a surface of the tooth on the other side in the circumferential direction of the gear axis with respect to the tooth tip portion with the left tooth flank of the second region; wherein
the thread includes at least one of a tool configuration including:
a tool configuration in which a tooth profile of the first region is recessed more than a tooth profile of the second region on the left tooth flank; and
a tool configuration in which a tooth profile of the second region is recessed more than a tooth profile of the first region on the right tooth flank.

20. The method of machining according to claim 19, wherein
the thread machines a tooth bottom of the gear in such a way that, after machining a surface of the tooth on one side in a circumferential direction, the tool driver or the gear driver shifts a phase of rotation of the tool with respect to rotation of the gear, or shifts a relative position between the tool and the gear in a direction intersecting the gear axis.
